(19) United States
(12) Patent Application Publication
(10) Pub. No.: US 2025/0287351 A1
(43) Pub. Date: Sep. 11, 2025

(54) FIRST NETWORK NODE, WIRELESS DEVICE, AND METHODS PERFORMED THEREBY FOR CONFIGURING CONFIGURED GRANTS FOR THE WIRELESS DEVICE

(71) Applicant: TELEFONAKTIEBOLAGET LM ERICSSON (PUBL), Stockholm (SE)

(72) Inventors: Jan CHRISTOFFERSSON, LULEÅ (SE); Andreas HOGLUND, SOLNA (SE); Henrik ENBUSKE, STOCKHOLM (SE); Tuomas TIRRONEN, HELSINKI (FI)

(21) Appl. No.: 18/551,922

(22) PCT Filed: Mar. 22, 2022
(86) PCT No.: PCT/SE2022/050268

§ 371 Date: Sep. 22, 2023

Related U.S. Application Data
(60) Provisional application No. 63/164,629, filed on Mar. 23, 2021.

(51) Int. Cl. H04W 68/00; H04W 72/1273

(52) U.S. Cl. CPC H04W 68/005; H04W 72/1273

(57) ABSTRACT

A method performed by a first network node (111). The method is for configuring a wireless device (130). The first network node (111) operates in the wireless communications network (100). The first network node (111) configures (302) the wireless device (130) with one or more configured grants to transmit data in inactive state. The data has a size smaller than a threshold. The one or more configured grants are configured by the first network node (111) with a relation to one or more occasions to monitor a paging channel between the first network node (111) and the wireless device (130).

### TECHNICAL FIELD

The present disclosure relates generally to a first network node, and methods performed thereby, for configuring a wireless device. The present disclosure also relates generally to a wireless device and methods performed thereby for configuring the wireless device.

### BACKGROUND

Wireless devices within a wireless communications network may be e.g., User Equipments (UE), stations (STAs), mobile terminals, wireless terminals, terminals, and/or Mobile Stations (MS). Wireless devices are enabled to communicate wirelessly in a cellular communications network or wireless communication network, sometimes also referred to as a cellular radio system, cellular system, or cellular network. The communication may be performed e.g., between two wireless devices, between a wireless device and a regular telephone and/or between a wireless device and a server via a Radio Access Network (RAN) and possibly one or more core networks, comprised within the wireless communications network. Wireless devices may further be referred to as mobile telephones, cellular telephones, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

The wireless communications network covers a geographical area which may be divided into cell areas, each cell area being served by a network node, which may be an access node such as a radio network node, radio node or a base station, e.g., a Radio Base Station (RBS), which sometimes may be referred to as e.g., gNB, evolved Node B (“eNB”), “eNodeB”, “NodeB”, “B node”, Transmission Point (TP), or BTS (Base Transceiver Station), depending on the technology and terminology used. The base stations may be of different classes such as e.g., Wide Area Base Stations, Medium Range Base Stations, Local Area Base Stations, Home Base Stations, pico base stations, etc . . . . , based on transmission power and thereby also cell size. A cell is the geographical area where radio coverage is provided by the base station or radio node at a base station site, or radio node site, respectively. One base station, situated on the base station site, may serve one or several cells. Further, each base station may support one or several communication technologies. The base stations communicate over the air interface operating on radio frequencies with the terminals within range of the base stations. The wireless communications network may also be a non-cellular system, comprising network nodes which may serve receiving nodes, such as wireless devices, with serving beams. In 3rd Generation Partnership Project (3GPP) Long Term Evolution (LTE), base stations, which may be referred to as eNodeBs or even eNBs, may be directly connected to one or more core networks. In the context of this disclosure, the expression Downlink (DL) may be used for the transmission path from the base station to the wireless device. The expression Uplink (UL) may be used for the transmission path in the opposite direction i.e., from the wireless device to the base station.

The standardization organization 3GPP is currently in the process of specifying a New Radio Interface called NR or 5G-UTRA, as well as a Fifth Generation (5G) Packet Core Network, which may be referred to as Next Generation (NG) Core Network, abbreviated as NG-CN, NGC or 5G CN.

### Internet of Things (IoT)

The Internet of Things (IoT) may be understood as an internetworking of communication devices, e.g., physical devices, vehicles, which may also be referred to as “connected devices” and “smart devices”, buildings and other items-embedded with electronics, software, sensors, actuators, and network connectivity that may enable these objects to collect and exchange data. The IoT may allow objects to be sensed and/or controlled remotely across an existing network infrastructure.

“Things,” in the IoT sense, may refer to a wide variety of devices such as heart monitoring implants, biochip transponders on farm animals, electric clams in coastal waters, automobiles with built-in sensors, DNA analysis devices for environmental/food/pathogen monitoring, or field operation devices that may assist firefighters in search and rescue operations, home automation devices such as the control and automation of lighting, heating, e.g. a “smart” thermostat, ventilation, air conditioning, and appliances such as washer, dryers, ovens, refrigerators or freezers that may use telecommunications for remote monitoring. These devices may collect data with the help of various existing technologies and then autonomously flow the data between other devices.

It is expected that in a near future, the population of IoT devices will be very large. Various predictions exist, among which one assumes that there will be >60000 devices per square kilometer, and another assumes that there will be 1000000 devices per square kilometer. A large fraction of these devices is expected to be stationary, e.g., gas and electricity meters, vending machines, etc.

### Machine Type Communication (MTC)

Machine Type Communication (MTC) has in recent years, especially in the context of the Internet of Things (IoT), shown to be a growing segment for cellular technologies. An MTC device may be a communication device, typically a wireless communication device or simply user equipment, that is, a self and/or automatically controlled unattended machine and that is typically not associated with an active human user in order to generate data traffic. An MTC device may be typically simpler, and typically associated with a more specific application or purpose than, and in contrast to, a conventional mobile phone or smart phone. MTC involves communication in a wireless communication network to and/or from MTC devices, which communication typically may be of quite different nature and with other requirements than communication associated with e.g., conventional mobile phones and smart phones. In the context of and growth of the IoT, it is evident that MTC traffic will be increasing and thus needs to be increasingly supported in wireless communication systems.

### Nr Small Data Transmissions in Inactive State

A new Work Item (WI) RP-200954, ‘New Work Item on NR small data transmissions in INACTIVE state’ has been approved in 3GPP with the focus of optimizing the transmission for small data payloads by reducing the signalling overhead. The WI contains the following relevant objectives. This work item may be understood to enable small data transmission in RRC_INACTIVE state as follows. For the RRC_INACTIVE state, for UL small data transmissions for Random Access CHannel (RACH)-based schemes, i.e., 2-step and 4-step RACH, to provide general procedure to enable User Plane (UP) data transmission for small data packets from INACTIVE state, e.g., using MSGA or MSG3 [RAN2]. Also, to enable flexible payload sizes larger than the Rel-16 Common Control Channel (CCCH) message size that may be possible currently for INACTIVE state for MSGA and MSG3 to support User Plane (UP) data transmission in UL. Actual payload size may be up to network configuration [RAN2]. Further, to provide context fetch and data forwarding, with and without anchor relocation, in INACTIVE state for RACH-based solutions [RAN2, RAN3]. The security aspects of the above solutions should be checked with 3GPP Technical Specification Group SA Work Group 3 (SA3).

Additionally, for the RRC_INACTIVE state, for transmission of UL data on pre-configured Physical Uplink Shared Channel (PUSCH) resources, that is, reusing the configured grant type 1, when Time Alignment (TA) may be valid, to provide general procedure for small data transmission over configured grant type 1 resources from INACTIVE state [RAN2]. Also, to provide configuration of the configured grant type1 resources for small data transmission in UL for INACTIVE state [RAN2]. A configured grant may be understood as a recurring set of preconfigured radio resources where a UE may transmit without receiving a dynamic grant.

For Narrow Band IoT (NB-IoT) and LTE-Machine Type Communication (LTE-M), similar signalling optimizations for small data have been introduced through Rel-15 Early Data Transmission (EDT) and Rel-16 Preconfigured Uplink Resources (PUR). Somewhat similar solutions may be expected for NR with the difference that the Rel-17 NR Small Data may have to only to be supported for Radio Resource Control (RRC) INACTIVE state, may include also 2-step RACH based small data, and that it may need to also include regular complexity Mobile BroadBand (MBB) UEs. Both may support mobile originated (MO) traffic only.

Within the context of Small Data Transmission (SDT), the possibility of transmitting subsequent data has been discussed, meaning transmission of further segments of the data that cannot fit in the Msg3 Transport Block. Such segments of data may be transmitted either in RRC_CONNECTED, as in legacy after the 4-step RACH procedure has been completed, or they may be transmitted in RRC_INACTIVE, before the UE may transition to RRC_CONNECTED. In the former case, the transmission may be more efficient, as the gNB and UE may be appropriately configured based on the current UE channel conditions, while in the latter case several optimizations may not be in place yet, especially if the UE has moved while not connected, and also the transmission may collide with the transmission from other UEs, as the contention may be understood to not have been resolved yet.

The Work Item has already started in 3GPP meeting RAN2 #111-e, and the following relevant agreements have already been made [2]: a) small data transmission with RRC message may be supported as baseline for Random Access (RA)-based and Configured Grant (CG) based schemes; b) the 2-step RACH or 4-step RACH may need to be applied to RACH based uplink small data transmission in RRC_INACTIVE; c) the uplink small data may be sent in MSGA of 2-step RACH or msg3 of 4-step RACH; d) small data transmission may be configured by the network on a per Data Radio Bearer (DRB) basis; e) data volume threshold may be used for the UE to decide whether to do SDT or not. For Further Study (FFS) how to calculate data volume; f) FFS if an “additional SDT specific” Reference Signal Received Power (RSRP) threshold may be further used to determine whether the UE should do SDT; g) UL/DL transmission following UL SDT without transitioning to RRC_CONNECTED may be supported; h) when UE is in RRC_INACTIVE, it may be possible to send multiple UL and DL packets as part of the same SDT mechanism and without transitioning to RRC_CONNECTED on dedicated grant. FFS on details and whether any indication to network may be needed.

It may be noted that some of the mechanisms discussed in this document are already agreed, therefore they do not represent the object of the embodiments herein, they serve the purpose of presenting a complete working solution.

In RAN2 #112-e, the following agreements have been made that concern Configured grants. A first agreement is that the configuration of configured grant resource for UE uplink small data transfer may be contained in the RRCRelease message. FFS if other dedicated messages can configure CG in INACTIVE CG. Configuration is only type 1 CG with no contention resolution procedure for CG. A second agreement is that the configuration of configured grant resource may include one type 1 CG configuration, which may be understood to be configured and activated by RRC. FFS if multiple configured CGs, e.g., occurring with different periodicities and of different “sizes”, may be allowed. A third agreement is that a new Time Alignment (TA) timer for TA maintenance specified for configured grant based small data transfer in RRC_INACTIVE may need to be introduced. FFS on the procedure, the validity of TA, and how to handle expiration of TA timer. The TA timer may be configured together with the CG configuration in the RRCRelease message. A fourth agreement is that the configuration of configured grant resource for UE small data transmission may be valid only in the same serving cell. FFS for other CG validity criteria, e.g., timer, UL/Supplementary Uplink (SUL) aspect, etc. A fifth agreement is that the UE may use configured grant based small data transfer if at least the following criteria is fulfilled: (1) user data is smaller than the data volume threshold; (2) configured grant resource is configured and valid; and (3) UE has valid TA. FFS for the candidate beam criteria. A sixth agreement is that from the RAN2 point of view, an association between CG resources and Synchronization Signal Blocks (SSBs) may be required for CG-based SDT. FFS up to RAN1 how the association may be configured or provided to the UE. A Liaison Statement (LS) could be sent to RAN1 to start the discussion on how the association may be made. It was mentioned that one option RAN2 considered was explicit configuration with the RRC Release message.

A Synchronization Signal (SS)-Reference Signal Received Power (RSRP) threshold may be configured for SSB selection. A UE may select one of the SSB with SS-RSRP above the threshold and select the associated CG resource for UL data transmission

In RAN2 #113, the following agreements were made concerning Configured Grants. A first agreement was that CG-SDT resource configuration may be provided to UEs in RRC_Connected only within the RRCRelease message, that is, there may be understood to be no need to also include it in RRCReconfiguration message. A second agreement was that CG-PUSCH resources may be separately configured for Normal Uplink (NUL) and SUL.

FFS if they are allowed at the same time. This may depend on the alignments CRs for Rel-16. A third agreement was that the RRCRelease message may be used to reconfigure or release the CG-SDT resources while UE may be in RRC_INACTIVE. A fourth agreement was that, for CG-SDT, the subsequent data transmission may use the CG resource or a Dedicated Grant (DG), that is, a dynamic grant addressed to a UE's Cell Radio Network Temporary Identifier (C-RNTI). Details on the C-RNTI, on whether it may be the same as the previous C-RNTI, or may be configured explicitly by the network may, be discussed in stage 3. A fifth agreement was that a Timing Advance Timer (TAT)-SDT may be started upon receiving the TAT-SDT configuration from the gNB, that is, the RRCrelease message, and may be (re) started upon reception of the TA command. A sixth agreement was that, from the RAN2 point of view, it may be assumed, similar to PUR, that a TA validation mechanism for SDT may be introduced based on a RSRP change, that is, an RSRP-based threshold(s) may be configured. RAN1 was to be asked to confirm. FFS on how to handle CG configuration when TA may expire or when it may be invalid due to RSRP threshold. Details of the TA validation procedure may be further discussed. A seventh agreement was that as a baseline assumption, it may be a network configuration issue whether to support multiple CG-SDT configurations per carrier in RRC_INACTIVE. Network configuration may not be restricted for now. An eighth agreement was that it was left FFS to discuss further in stage 3 how to specify the agreement that CG-SDT resources may only be valid in one cell, that is, the cell in which the RRCRelease may have been received. A ninth agreement was that the UE may release CG-SDT resources when TAT may expire in RRC_Inactive state.

A further agreement was that upon initiating SDT, after the carrier selection, if valid CG-SDT resource exists, then CG-SDT may be chosen, otherwise the UE may proceed to RA-SDT procedure.

An additional agreement was that RAN2 may continue to progress the work based on the separate RACH resources for SDT, that is, that explicit mechanisms to support common resources may not be pursued unless there may be sufficient support for this. However, use of common RACH resources may not be precluded if possible via implementation.

A first additional agreement was that RAN2 design may assume that the RRCRelease message may be sent at the end to terminate the SDT procedure from the RRC point of view. The RRCRelease sent at the end of the SDT may contain the CG resource, as per a previous agreement.

A second additional agreement was that the UE behavior for handling of non-SDT data arrival after sending the first UL data packet may be fully specified, that is, not left to UE implementation.

A third additional agreement was that it was left FFS that RAN2 may consider the additional option of using a Dedicated Control CHannel (DCCH) message to indicate arrival of non-SDT data, with details to be discussed. Discussion was to continue on all three options.

A fourth additional agreement was that it was left FFS an RSRP threshold to select between SDT and non-SDT procedure.

A fifth additional agreement was that FFS also whether this RSRP threshold to select between SDT and non-SDT procedure may be used for CG-SDT, RA-SDT, or both and whether the RSRP threshold may be the same for CG-SDT and RA-SDT. It was left FFS when the RSRP threshold check may be made.

A sixth additional agreement was that it was left FFS if both carriers, UL and SUL, may be selected and if CG resources are available on one carrier only, does the UE select the carrier with CG?

A seventh additional agreement was that for SDT, the UE may perform UL carrier selection. That is, if SUL is configured in the cell, the UL carrier may be selected based on RSRP threshold. It was left FFS whether the RSRP threshold for carrier selection may be specific to SDT.

An eighth additional agreement was that if CG-SDT resources are configured on the selected UL carrier and are valid, then CG-SDT may be chosen. Otherwise, if 2 step RA-SDT resources are configured on the UL carrier and criteria to select the 2 step RA SDT are met, then 2 step RA-SDT may be chosen. Else, if 4 step RA-SDT resources are configured on the UL carrier and criteria to select 4 step RA SDT are met, then 4 step RA-SDT may be chosen. Else, the UE may not perform SDT, that is, it may perform a non-SDT resume procedure. If both 2 step RA-SDT and 4 step RA-SDT resources are configured on the UL carrier, RA type selection may be performed based on an RSRP threshold. It was left FFS whether the RSRP threshold for RA type selection is common or different for SDT and non SDT. It was also left FFS what validity may include if it may be needed to deal with a CG resource availability delay.

### Paging in NR

The following description of the paging procedure is from 3GPP TS 38.300, v. 16.4.0, and any citations provided in brackets may be understood to be cited as such in this specification.

Paging may be understood to allow the network to reach UEs in RRC_IDLE and in RRC_INACTIVE state through Paging messages, and to notify UEs in RRC_IDLE, RRC_INACTIVE and RRC_CONNECTED state of a change in system information, see clause 7.3.3, and Earthquake and Tsunami Warning System (ETWS)/Commercial Mobile Alert Service (CMAS) indications, see clause 16.4, through Short Messages. Both Paging messages and Short Messages may be addressed with Paging-Radio Network Temporary Identifier (P-RNTI) on Physical Downlink Control CHannel (PDCCH), but while the former may be sent on Paging Control CHannel (PCCH), the latter may be sent over PDCCH directly, see clause 6.5 of TS 38.331 [12].

While in RRC_IDLE the UE may monitor the paging channels for Core Network (CN)-initiated paging; in RRC_INACTIVE, the UE may also monitor paging channels for RAN-initiated paging. A UE need not monitor paging channels continuously though; Paging Discontinuous Reception (DRX) may be defined where the UE in RRC_IDLE or RRC_INACTIVE may be only required to monitor paging channels during one Paging Occasion (PO) per DRX cycle, see TS 38.304 [10]. The Paging DRX cycles may be configured by the network: 1) for CN-initiated paging, a default cycle may be broadcast in system information; 2) for CN-initiated paging, a UE specific cycle may be configured via Non-Access Stratum (NAS) signalling; and 3) for RAN-initiated paging, a UE-specific cycle may be configured via RRC signalling. The UE may use the shortest of the DRX cycles applicable, that is, a UE in RRC_IDLE may use the shortest of the first two cycles above, while a UE in RRC_INACTIVE may use the shortest of the three.

The Paging Occasions (POs) of a UE for CN-initiated and RAN-initiated paging may be based on the same UE IDentifier (ID), resulting in overlapping POs for both. The number of different POs in a DRX cycle may be configurable via system information, and a network may distribute UEs to those POs based on their IDs.

When in RRC_CONNECTED, the UE may monitor the paging channels in any PO signalled in system information for System Information (SI) change indication and Public Warning System (PWS) notification. In case of Bandwidth Adaptation (BA), a UE in RRC_CONNECTED may only monitor paging channels on the active BandWidth Part (BWP) with common search space configured.

For operation with shared spectrum channel access, a UE may be configured for an additional number of Physical Downlink Control Channel (PDCCH) monitoring occasions in its PO to monitor for paging. However, when the UE detects a PDCCH transmission within the UE's PO addressed with Paging-Radio Network Temporary Identifier (P-RNTI), the UE may not be required to monitor the subsequent PDCCH monitoring occasions within this PO.

Paging optimization for UEs in Connection Management (CM)_IDLE: at UE context release, the Next Generation-Radio Access Network (NG-RAN) node may provide the Access and Mobility Management Function (AMF) with a list of recommended cells and NG-RAN nodes as assistance information for subsequent paging. The AMF may also provide Paging Attempt Information consisting of a Paging Attempt Count and the Intended Number of Paging Attempts, and may include the Next Paging Area Scope. If Paging Attempt Information is included in the Paging message, each paged NG-RAN node may receive the same information during a paging attempt. The Paging Attempt Count may need to be increased by one at each new paging attempt. The Next Paging Area Scope, when present, may indicate whether the AMF plans to modify the paging area currently selected at next paging attempt. If the UE has changed its state to CM CONNECTED, the Paging Attempt Count may be reset.

Paging optimization for UEs in RRC_INACTIVE: at RAN Paging, the serving NG-RAN node may provide RAN Paging area information. The serving NG-RAN node may also provide RAN Paging attempt information. Each paged NG-RAN node may receive the same RAN Paging attempt information during a paging attempt with the following content: Paging Attempt Count, the intended number of paging attempts and the Next Paging Area Scope. The Paging Attempt Count may need to be increased by one at each new paging attempt. The Next Paging Area Scope, when present, may indicate whether the serving NG_RAN node may plan to modify the RAN Paging Area currently selected at the next paging attempt. If the UE leaves RRC_INACTIVE state, the Paging Attempt Count may be reset.

More details of the paging procedure may be found in 3GPP TS 38.304, v 16.3.0, from where the following text is from.

The UE may use DRX in RRC_IDLE and RRC_INACTIVE state in order to reduce power consumption. The UE may monitor one PO per DRX cycle. A PO may be understood as a set of PDCCH monitoring occasions and can consist of multiple time slots, e.g., subframe or Orthogonal Frequency Division Multiplexing (OFDM) symbol, where paging Downlink Control Information (DCI) may be sent, see TS 38.213 [4]. One Paging Frame (PF) may be understood as one Radio Frame and may contain one or multiple PO(s) or starting point of a PO.

In multi-beam operations, the UE may assume that the same paging message and the same Short Message may be repeated in all transmitted beams and thus the selection of the beam(s) for the reception of the paging message and Short Message may be up to UE implementation. The paging message may be same for both RAN initiated paging and CN initiated paging.

The UE may initiate RRC Connection Resume procedure upon receiving RAN initiated paging. If the UE receives a CN initiated paging in RRC_INACTIVE state, the UE may move to RRC_IDLE and inform NAS.

The PF and PO for paging may be determined by the following formulae:

SubFrame Number (SFN) for the PF may be determined by.:

$$( S F N + PF\_offset ) mod T = ( T div N ) * ( UE\_ID mod N )$$

Where “N” may be understood to be the number of total paging frames in T, and T may be a DRX cycle of the UE. T may be determined by the shortest of the UE specific DRX value(s), if configured by RRC and/or upper layers, and a default DRX value broadcast in system information. In RRC_IDLE state, if UE specific DRX is not configured by upper layers, the default value may be applied. PF_offset may be understood to be the offset used for PF determination. UE_ID may be understood to be the 5G System Architecture Evolution-Temporary Mobile Subscriber Identity (5G-S-TMSI) mod 1024.

Index (i_s), indicating the index of the PO may be determined by:

$$i\_s = floor ( UE\_ID / N ) mod Ns$$

Where “Ns” may be understood to be the number of paging occasions for a PF

The PDCCH monitoring occasions for paging may be determined according to pagingSearchSpace as specified in TS 38.213 [4] and firstPDCCH-MonitoringOccasionOfPO and nrofPDCCH-MonitoringOccasionPerSSB-InPO if configured as specified in TS 38.331 [3]. When SearchSpaceId=0 is configured for pagingSearchSpace, the PDCCH monitoring occasions for paging may be the same as for Remaining Minimum System Information (RMSI) as defined in clause 13 in TS 38.213 [4].

When SearchSpaceId=0 is configured for pagingSearchSpace, Ns may be either 1 or 2. For Ns=1, there may be only one PO which may start from the first PDCCH monitoring occasion for paging in the PF. For Ns=2, PO may be either in the first half frame (i_s=0) or the second half frame (i_s=1) of the PF.

When SearchSpaceId other than 0 is configured for pagingSearchSpace, the UE may monitor the (i_s+1)th PO. A PO may be a set of ‘S*X’ consecutive PDCCH monitoring occasions where ‘S’ may be understood to be the number of actual transmitted SSBs determined according to ssb-PositionsinBurst in SIB1 and X may be understood to be the nrofPDCCH-MonitoringOccasionPerSSB-InPO if configured or may be equal to 1 otherwise. The [x*S+K]^{th} PDCCH monitoring occasion for paging in the PO may correspond to the Kth transmitted SSB, where x=0,1, . . . , X−1, K=1, 2, . . . , S. The PDCCH monitoring occasions for paging which do not overlap with UL symbols, determined according to tdd-UL-DL-ConfigurationCommon, may be sequentially numbered from zero starting from the first PDCCH monitoring occasion for paging in the PF. When firstPDCCH-MonitoringOccasionOfPO is present, the starting PDCCH monitoring occasion number of (i_s+1)^{th} PO may be the (i_s+1)^{th} value of the firstPDCCH-MonitoringOccasionOfPO parameter; otherwise, it may be equal to i_s*S*X. If X>1, when the UE may detect a PDCCH transmission addressed to P-RNTI within its PO, the UE may not be required to monitor the subsequent PDCCH monitoring occasions for this PO. It may be noted that a PO associated with a PF may start in the PF or after the PF. It may also be noted that the PDCCH monitoring occasions for a PO may span multiple radio frames. When SearchSpaceId other than 0 is configured for paging-SearchSpace, the PDCCH monitoring occasions for a PO may span multiple periods of the paging search space.

Parameters Ns, nAndPagingFrameOffset, nrofPDCCH-MonitoringOccasionPerSSB-InPO, and the length of default DRX Cycle may be signaled in SIB1. The values of N and PF_offset may be derived from the parameter nAndPagingFrameOffset as defined in TS 38.331 [3]. The parameter first-PDCCH-MonitoringOccasionOfPO may be signalled in SIB1 for paging in initial DL BWP. For paging in a DL BWP other than the initial DL BWP, the parameter first-PDCCH-MonitoringOccasionOfPO may be signalled in the corresponding BWP configuration.

If the UE has no 5G-S-TMSI, for instance when the UE has not yet registered onto the network, the UE may be required to use as default identity UE_ID=0 in the PF and i_s formulas above.

5G-S-TMSI may be understood to be a 48 bit long bit string as defined in 3GPP TS 23.501 [10]. 5G-S-TMSI may be required in the formulae above to be interpreted as a binary number where the left most bit may represent the most significant bit.

In the Paging procedure described in 3GPP TS 38.300 and 3GPP TS 38.304, it may be observed that the PO that a specific UE may monitor may depend on its UE id, and other parameters configured by RRC, meaning that different UEs may or may not monitor the same POs. This may be understood to ensure that different UEs may be more or less equally distributed over different POs to avoid congestion.

### Configured Grant in NR

The CG may be configured in the ConfiguredGrantConfig IE, which is specified in 3GPP TS 38.331, v. 16.3.1, according to:

| | |
|---|---|
| ConfiguratedGrantConfig ::= | SEQUENCE { |
| frequencyHopping | ENUMERATED {intraSlot, |
| interSlot} | OPTIONAL, -- Need |

S

| | |
|---|---|
| cg-DMRS-Configuration | DMRS-UplinkConfig, |
| mcs-Table | ENUMERATED {qam256, |
| qam64LowSE} | OPTIONAL, -- |

Need S

| | |
|---|---|
| mcs-TableTransformPrecoder | ENUMERATED {qam256, |
| qam64LowSE} | OPTIONAL, -- |

Need S

| | |
|---|---|
| uci-OnPUSCH | SetupRelease { CG-UCI-OnPUSCH |
| } | OPTIONAL, -- Need M |
| resourceAllocation | ENUMERATED { |

resourceAllocationType0, resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, |
| disabled} | OPTIONAL, -- |

Need S

| | |
|---|---|
| nrofHARQ-Processes | INTEGER(1..16), |
| repK | ENUMERATED {n1, n2, n4, n8}, |
| repK-RV | ENUMERATED {s1-0231, s2-0303, |
| s3-0000} | OPTIONAL, -- Need R |
| periodicity | ENUMERATED { |
| | sym2, sym7, sym1x14, |

sym2x14, sym4x14, sym5x14, sym8x14, sym10x14, sym16x14, sym20x14,

sym32x14, sym40x14,

sym64x14, sym80x14, sym128x14, sym160x14, sym256x14, sym320x14,
sym512x14,

sym640x14,

sym1024x14, sym1280x14, sym2560x14, sym5120x14,

sym6, sym1x12,

sym2x12, sym4x12, sym5x12, sym8x12, sym10x12, sym16x12, sym20x12,
sym32x12,

sym40x12, sym64x12,

sym80x12, sym128x12, sym160x12, sym256x12, sym320x12, sym512x12,
sym640x12,

sym1280x12,

sym2560x12,
},

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |
| dmrs-SeqInitialization | INTEGER |

(0..1)
OPTIONAL, -- Need R

| | |
|---|---|
| precodingAndNumberOfLayers | INTEGER (0..63), |
| srs-ResourceIndicator | INTEGER (0..15) |

OPTIONAL, -- Need R

| | |
|---|---|
| mcsAndTBS | INTEGER (0..31), |
| frequencyHoppingOffset | INTEGER (1.. |
| maxNrofPhysicalResourceBlocks-1) | OPTIONAL, |

-- Need R

| | |
|---|---|
| pathlossReferenceIndex | INTEGER (0..maxNrofPUSCH- |

```
PathlossReferencesRSs-1),
    ...,
    [[
```

| | |
|---|---|
| pusch-RepTypeIndicator-r16 | ENUMERATED {pusch- |
| RepTypeA,pusch-RepTypeB} | OPTIONAL, -- |

Need M

| | |
|---|---|
| frequencyHoppingPUSCH-RepTypeB-r16 | ENUMERATED |

{interRepetition, interSlot}
OPTIONAL, -- Cond RepTypeB

| | |
|---|---|
| timeReferenceSFN-r16 | ENUMERATED {sfn512} |

```
OPTIONAL -- Need S
    ]]
  }
OPTIONAL, -- Need R
  ...,
  [[
```

| | |
|---|---|
| cg-RetransmissionTimer-r16 | INTEGER (1..64) |

OPTIONAL, -- Need R

| | |
|---|---|
| cg-minDFI-Delay-r16 | ENUMERATED |
| | {sym7, sym1x14, |

sym2x14, sym3x14, sym4x14, sym5x14, sym6x14, sym7x14, sym8x14,

sym9x14,

sym10x14, sym11x14, sym12x14, sym13x14, sym14x14,sym15x14, sym16x14,

}

OPTIONAL, -- Need R

| | |
|---|---|
| cg-nrofPUSCH-InSlot-r16 | INTEGER (1..7) |

OPTIONAL, -- Need R

| | |
|---|---|
| cg-nrofSlots-r16 | INTEGER (1..40) |

OPTIONAL, -- Need R

| | |
|---|---|
| cg-StartingOffsets-r16 | CG-StartingOffsets-r16 |

OPTIONAL, -- Need R

| | |
|---|---|
| cg-UCI-Multiplexing | ENUMERATED {enabled} |

OPTIONAL, -- Need R

| | |
|---|---|
| cg-COT-SharingOffset-r16 | INTEGER (1..39) |

OPTIONAL, -- Need R

| | |
|---|---|
| betaOffsetCG-UCI-r16 | INTEGER (0.. 31) |

OPTIONAL, -- Need R

| | |
|---|---|
| cg-COT-SharingList-r16 | SEQUENCE (SIZE (1..1709)) |
| OF CG-COT-Sharing-r16 | OPTIONAL, -- Need R |
| harq-ProcID-Offset-r16 | INTEGER (0..15) |

OPTIONAL, -- Need M

| | |
|---|---|
| harq-ProcID-Offset2-r16 | INTEGER (0..15) |

```
OPTIONAL, -- Need M
  configuredGrantConfigIndex-r16
ConfiguredGrantConfigIndex-r16
OPTIONAL, -- Cond CG-List
  configuredGrantConfigIndexMAC-r16
ConfiguredGrantConfigIndexMAC-r16
OPTIONAL, -- Cond CG-List
```

| | |
|---|---|
| periodicityExt-r16 | INTEGER (1..5120) |

OPTIONAL, -- Need R

| | |
|---|---|
| startingFromRV0-r16 | ENUMERATED {on, off} |

OPTIONAL, -- Need R

| | |
|---|---|
| phy-PriorityIndex-r16 | ENUMERATED {p0, p1} |

OPTIONAL, -- Need R

| | |
|---|---|
| autonomousTx-r16 | ENUMERATED {enabled} |

OPTIONAL -- Cond LCH-BasedPrioritization
]]
}
CG-UCI-OnPUSCH ::= CHOICE {

| | |
|---|---|
| dynamic | SEQUENCE (SIZE (1..4)) OF |

BetaOffsets,

| | |
|---|---|
| semiStatic | BetaOffsets |

}
CG-COT-Sharing-r16 ::= CHOICE {

| | |
|---|---|
| noCOT-Sharing-r16 | NULL, |
| cot-Sharing-r16 | SEQUENCE { |
| duration-r16 | INTEGER (1.. 39), |
| offset-r16 | INTEGER (1.. 39), |
| channelAccessPriority-r16 | INTEGER (1..4) |

}
}
CG-StartingOffsets-r16 ::= SEQUENCE {

| | |
|---|---|
| cg-StartingFullBW-InsideCOT-r16 | SEQUENCE (SIZE (1..7)) OF |
| INTEGER (0..6) | OPTIONAL, -- Need R |
| cg-StartingFullBW-OutsideCOT-r16 | SEQUENCE (SIZE (1..7)) OF |
| INTEGER (0..6) | OPTIONAL, -- Need R |
| cg-StartingPartialBW-InsideCOT-r16 | INTEGER (0..6) |

OPTIONAL, -- Need R

| | |
|---|---|
| cg-StartingPartialBW-OutsideCOT-r16 | INTEGER (0..6) |

OPTIONAL, -- Need R
}
-- TAG-CONFIGUREDGRANTCONFIG-STOP
-- ASN1STOP

The periodicity of the CG transmission occasions may be given by the parameter periodicity or periodicityExt. The maximum value that may be configured may be 640 ms for 15 kHz SCS.

periodicity
Periodicity for UL transmission without UL grant for type 1 and type 2
(see TS 38.321 [3], clause 5.8.2).
The following periodicities may be supported depending on the configured
subcarrier spacing [symbols]:
15 kHz: 2, 7, n*14, where n = {1, 2, 4, 5, 8, 10, 16, 20, 32, 40, 64, 80,
128, 160, 320, 640}
30 kHz: 2, 7, n*14, where n = {1, 2, 4, 5, 8, 10, 16, 20, 32, 40, 64, 80,
128, 160, 256, 320, 640, 1280}
60 kHz with normal CP 2, 7, n*14, where n = {1, 2, 4, 5, 8, 10, 16, 20,
32, 40, 64, 80, 128, 160, 256, 320, 512, 640, 1280, 2560}
60 kHz with ECP: 2, 6, n*12, where n = {1, 2, 4, 5, 8, 10, 16, 20, 32, 40,
64, 80, 128, 160, 256, 320, 512, 640, 1280, 2560}
120 kHz: 2, 7, n*14, where n = {1, 2, 4, 5, 8, 10, 16, 20, 32, 40, 64, 80,
128, 160, 256, 320, 512, 640, 1024, 1280, 2560, 5120}
periodicityExt
This field may be used to calculate the periodicity for UL transmission
without UL grant for type 1 and type 2 (see TS 38.321 [3], clause 5, 8.2).
If this field is present, the field periodicity may be ignored.
The following periodicites may be supported depending on the configured
subcarrier spacing [symbols]:
15 kHz: periodicityExt*14, where periodicityExt has a value between 1
and 640.
30 kHz: periodicityExt*14, where periodicityExt has a value between 1
and 1280.
60 kHz with normal CP: periodicityExt*14, where periodicityExt has a
value between 1 and 2560.
60 kHz with ECP: periodicityExt*12, where periodicityExt has a value
between 1 and 2560.
120 kHz: periodicityExt*14, where periodicityExt has a value
between 1 and 5120.

Existing methods for a wireless device to transmit data in inactive state may result in a waste of energy resources, as well as overhead and interference, and negative affect the performance of a wireless communications network.

### SUMMARY

As part of the development of embodiments herein, one or more challenges with the existing technology will first be identified and discussed.

The main use case for configured grant for SDT may be understood to be small data with long periodicity, e.g., 10 seconds or more. This kind of data may be common for sensors for which low energy consumption may be understood to be also important. Given the current agreements that CG Type 1 may be required to be reused for CG based SDT, there is no possibility to configure long enough periodicities. In case CG periodicity is just increased, the UE may be understood to need to wake up both to transmit on the CG occasion and monitor PDCCH after the transmission, and to monitor for paging. This is depicted in FIG. 1. If a wireless device is awake often, the energy resources of the wireless device may be wasted, while overhead and interference may be created.

According to the foregoing, it is an object of embodiments herein to improve the handling of transmission of data by a wireless device in inactive state in a wireless communications network.

According to a first aspect of embodiments herein, the object is achieved by a method, performed by a first network node. The method is for configuring a wireless device. The first network node operates in the wireless communications network. The first network node then configures the wireless device with one or more configured grants to transmit data in inactive state. The data has a size smaller than a threshold. The one or more configured grants is configured by the first network node with a relation to one or more occasions to monitor a paging channel between the first network node and the wireless device.

According to a second aspect of embodiments herein, the object is achieved by a method, performed by a wireless device. The method is for obtaining the configuration. The wireless device operates in the wireless communications network. The wireless device obtains an indication from the first network node. The indication configures the wireless device with one or more configured grants to transmit data in inactive state. The data has the size smaller than the threshold. The one or more configured grants are configured by the first network node with the relation to the one or more occasions to monitor the paging channel between the first network node and the wireless device.

According to a third aspect of embodiments herein, the object is achieved by the first network node, for configuring the wireless device. The first network node is configured to operate in the wireless communications network. The first network node is further configured to configure the wireless device with the one or more configured grants to transmit data in inactive state. The data being is configured to have a size smaller than the threshold. The one or more configured grants are configured by the first network node with the relation to the one or more occasions to monitor the paging channel between the first network node and the wireless device.

According to a fourth aspect of embodiments herein, the object is achieved by the wireless device, for obtaining the configuration. The wireless device is configured to operate in the wireless communications network. The wireless device is further configured to obtain the indication from the first network node. The indication is configured to configure the wireless device with the one or more configured grants to transmit the data in inactive state. The data is configured to have the size smaller than the threshold. The one or more configured grants are configured by the first network node with the relation to the one or more occasions to monitor the paging channel between the first network node and the wireless device.

By the first network node configuring the wireless device with the one or more configured grants with the relation to the one or more occasions to monitor the paging channel, the first network node may enable that the amount of time the wireless device may need to be awake while in inactive state, may be minimized, while the wireless device may still be allowed to transmit small amounts of data. Hence, the wireless device may be enabled to save energy consumption. Furthermore, in some examples the first network node may also be enabled to reduce the signalling overhead, which may result in a reduction of interference and an improvement in the performance of the wireless communications network.

### BRIEF DESCRIPTION OF THE DRAWINGS

Examples of embodiments herein are described in more detail with reference to the accompanying drawings, and according to the following description.

FIG. 1 is a schematic representation depicting an example of when a UE is awake due to CG occasions and paging.

FIG. 2 is a schematic diagram illustrating a communications system, according to embodiments herein.

FIG. 3 is a flowchart depicting an example of a method in a first network node, according to embodiments herein.

FIG. 4 is a flowchart depicting an example of a method in a wireless device, according to embodiments herein.

FIG. 5 is a schematic representation depicting a non-limiting example of an example of when a wireless device may be awake according to embodiments herein.

FIG. 6 is a schematic representation depicting another non-limiting example of an example of when a wireless device may be awake according to embodiments herein.

FIG. 7 is a schematic block diagram illustrating two non-limiting examples, a) and b), of a first network node, according to embodiments herein.

FIG. 8 is a schematic block diagram illustrating two non-limiting examples, a) and b), of a wireless device, according to embodiments herein.

FIG. 9 is a flowchart depicting an example of a method in a wireless device, according to examples related to embodiments herein.

FIG. 10 is a schematic block diagram illustrating a telecommunication network connected via an intermediate network to a host computer, according to embodiments herein.

FIG. 11 is a generalized block diagram of a host computer communicating via a base station with a user equipment over a partially wireless connection, according to embodiments herein.

FIG. 12 is a flowchart depicting embodiments of a method in a communications system including a host computer, a base station and a user equipment, according to embodiments herein.

FIG. 13 is a flowchart depicting embodiments of a method in a communications system including a host computer, a base station and a user equipment, according to embodiments herein.

FIG. 14 is a flowchart depicting embodiments of a method in a communications system including a host computer, a base station and a user equipment, according to embodiments herein.

FIG. 15 is a flowchart depicting embodiments of a method in a communications system including a host computer, a base station and a user equipment, according to embodiments herein.

### DETAILED DESCRIPTION

Certain aspects of the present disclosure and their embodiments may provide solutions to the challenges discussed in the Summary section, or other challenges. There are, proposed herein, various embodiments which address one or more of the issues disclosed herein.

Embodiments herein may be understood to be related to methods to configure long periodicities for CG-SDT to reduce energy consumption.

In one option, the periodicity for CG may be related to the paging cycle of a wireless device, a UE. In this way, the wireless device may only need to be active in a time period close to the paging occasions, and may sleep other times. The relation of the CG transmission occasion may be fractions of the paging cycle or multiples of the paging cycle.

In another option, the paging may be aligned to the CG periodicity. In this case, the network node, e.g., a gNB, may hold and/or store the paging until next CG transmit (tx) occasion.

In another option, the wireless device may monitor a subset of paging occasions, for which some may be aligned with the CG periodicity.

In another option, paging may be disabled when the wireless device may be configured with CG-SDT, and instead the Network (NW) response in DL to CG-SDT UL transmission may be used for DL reachability.

Embodiments herein may be understood to be related to a method for providing alignment of CG transmission occasions and paging for SDT.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

Note that although terminology from LTE/5G has been used in this disclosure to exemplify the embodiments herein, this should not be seen as limiting the scope of the embodiments herein to only the aforementioned system. Other wireless systems with similar features, may also benefit from exploiting the ideas covered within this disclosure.

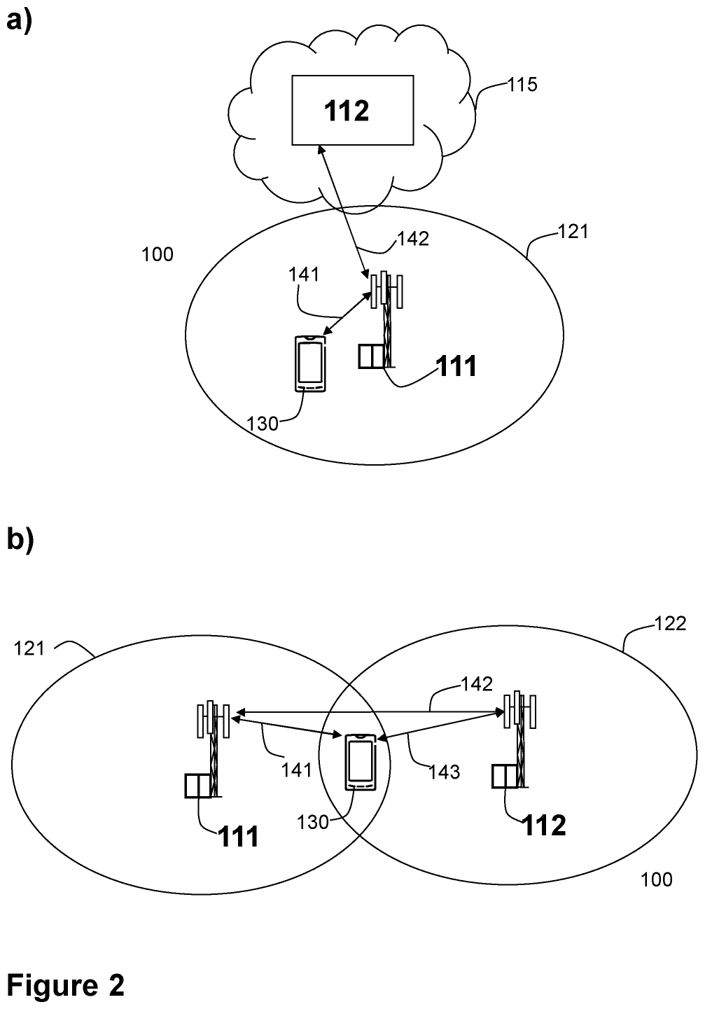

FIG. 2 depicts two non-limiting examples of a wireless communications network 100, sometimes also referred to as a wireless communications system, cellular radio system, or cellular network, in which embodiments herein may be implemented. The wireless communications network 100 may typically be a 5G system, 5G network, NR-U or Next Gen System or network, LAA, MulteFire. The wireless communications network 100 may support a younger system than a 5G system. The wireless communications network 100 may support other technologies, such as, for example Long-Term Evolution (LTE), LTE-Advanced/LTE-Advanced Pro, e.g., LTE Frequency Division Duplex (FDD), LTE Time Division Duplex (TDD), LTE Half-Duplex Frequency Division Duplex (HD-FDD), LTE operating in an unlicensed band, etc., Other examples of other technologies the wireless communications network 100 may support may be Wideband Code Division Multiple Access (WCDMA), Universal Terrestrial Radio Access (UTRA) TDD, Global System for Mobile communications (GSM) network, GSM/Enhanced Data Rate for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, WiFi networks, Worldwide Interoperability for Microwave Access (WiMax), IoT, NB-IoT, or any cellular network or system. Thus, although terminology from 5G/NR and LTE may be used in this disclosure to exemplify embodiments herein, this should not be seen as limiting the scope of the embodiments herein to only the aforementioned systems.

The wireless communications network 100 comprises a first network node 111, as depicted in the non-limiting example of panel a) in FIG. 2. In some embodiments, the wireless communications network 100 may comprise a plurality of network nodes, whereof the first network node 111 and a second network node 112 are depicted in the non-limiting example of panel a) and panel b) in FIG. 2. Any of the first network node 111 and the second network node 112 may be a radio network node. That is, a transmission point such as a radio base station, for example a gNB, an eNB, or any other network node with similar features capable of serving a wireless device, such as a user equipment or a machine type communication device, in the wireless communications network 100. In other examples, which are not depicted in FIG. 2, any of the first network node 111 and the second network node 112 may be a distributed node, such as a virtual node in the cloud 115, and may perform its functions entirely on the cloud 115, or partially, in collaboration with a radio network node. The first network node 111 and the second network node 112 may, in some examples, be co-located or be the same network node. In typical examples, such as those depicted in FIG. 2, the first network node 111 and the second network node 112 may be different nodes. In some examples, such as that depicted in panel a) of FIG. 2, the second network node 112 may be a core network node in the wireless communications network 100, such as for example, an AMF. In other examples, such as that depicted in panel b) of FIG. 2, the second network node 112 may be another radio network node in the wireless communications network 100. In such examples, the first network node 111 may be also referred to herein as a source node. The first network node 111 may also be referred to herein simply as a network node. The second network node 112 may be also referred to as a target network node.

The wireless communications network 100 covers a geographical area which may be divided into cell areas, wherein each cell area may be served by a network node, although, one radio network node may serve one or several cells. The wireless communications network 100 may comprise a first cell 121, which may be also referred to herein as a source cell. In some embodiments, the wireless communications network 100 may also comprise a second cell 122, which may be also referred to herein as a target cell.

Any of the first network node 111 and the second network node 112 may be of different classes, such as, e.g., macro base station, home base station or pico base station, based on transmission power and thereby also cell size. Any of the first network node 111 and the second network node 112 may support one or several communication technologies, and its name may depend on the technology and terminology used. In 5G/NR, any of the first network node 111 and the second network node 112 may be referred to as a gNB and may be directly connected to one or more core networks.

A plurality of wireless devices may be comprised in the wireless communication network 100, whereof a wireless device 130, is depicted in the non-limiting examples of FIG. 2. The wireless device 130 comprised in the wireless communications network 100 may be a wireless communication device such as a 5G UE, or a UE, which may also be known as e.g., mobile terminal, wireless terminal and/or mobile station, a mobile telephone, cellular telephone, or laptop with wireless capability, just to mention some further examples. Any of the wireless devices comprised in the wireless communications network 100 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, device equipped with a wireless interface, such as a printer or a file storage device, modem, or any other radio network unit capable of communicating over a radio link in a communications system. The wireless device 130 comprised in the wireless communications network 100 is enabled to communicate wirelessly in the wireless communications network 100. The communication may be performed e.g., via a RAN, and possibly the one or more core networks, which may be comprised within the wireless communications network 100.

The wireless device 130 may be configured to communicate within the wireless communications network 100 with the first network node 111 in the first cell 121 over a first link 141, e.g., a radio link. The first network node 111 and the second network node 112 may be configured to communicate within the wireless communications network 100 over a second link 142, e.g., a wired link, a radio link or an X2 interface. The wireless device 130 may be configured to communicate within the wireless communications network 100 with the second network node 112 in the second cell 122 over a respective third link 143, e.g., a radio link.

In general, the usage of “first”, “second”, “third” and/or “fourth” herein may be understood to be an arbitrary way to denote different elements or entities, and may be understood to not confer a cumulative or chronological character to the nouns they modify.

Several embodiments are comprised herein. Some embodiments herein will now be further described with some non-limiting examples. It should be noted that the examples herein are not mutually exclusive. Components from one embodiment may be tacitly assumed to be present in another embodiment and it will be obvious to a person skilled in the art how those components may be used in the other exemplary embodiments. In the following description, any reference to a/the network, and/or the network node, and/or the source node, and/or “gNB”, and/or “current gNB”, and/or “NG-RAN node”, and/or “the network” may be understood to equally refer to any of the first network node 111; any reference to a/the target node, and/or “another gNB”, and/or “anchor gNB”, and/or, based on context, “AMF” and/or “the CN” may be understood to equally refer to the second network node 112; any reference to a/the UE may be understood to equally refer the wireless device 130; any reference to a/the source cell, and/or a/the current serving cell may be understood to equally refer the first cell 121; any reference to a/the target cell may be understood to equally refer the second cell 122.

More specifically, the following are embodiments related to a first network node, such as the first network node 111, e.g., a gNB, and embodiments related to a wireless device, such as the wireless device 130, e.g., a UE.

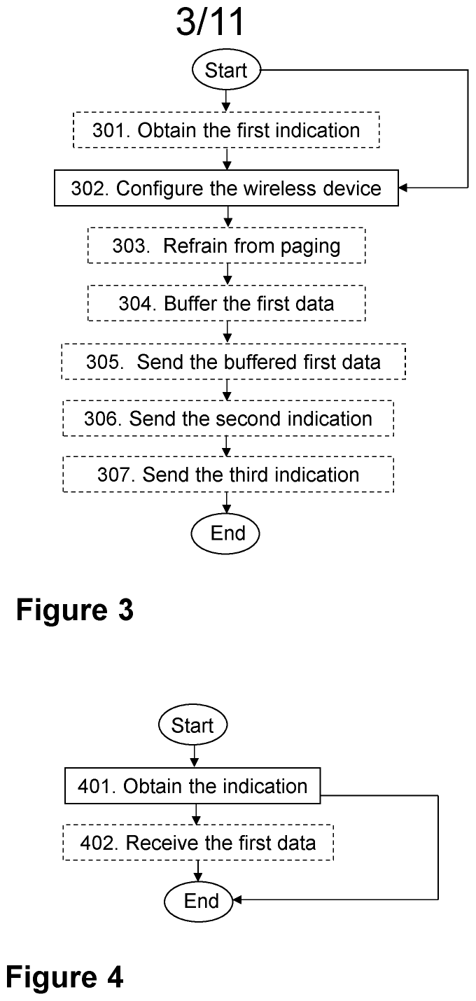

Embodiments of a method performed by a first network node, such as the first network node 111, will now be described with reference to the flowchart depicted in FIG. 3. The method may be understood to be for configuring a wireless device, such as the wireless device 130. The first network node 111 operates in the wireless communications network 100.

Several embodiments are comprised herein. In some embodiments all the actions may be performed. In some embodiments, one or more actions may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. Some actions may be performed in a different order than that shown FIG. 3. A non-limiting example of the method performed by the first network node 111 is depicted in FIG. 3.

In some embodiments, the first network node 111 may be a gNB. The second network node 112 may be another gNB, or an AMF. In some embodiments, the wireless device 130 may be a 5G UE.

### Action 301

In this Action 301, the first network node 111 may obtains a first indication. The first indication may indicate that the wireless device 130 is configured with one or more first configured grants to transmit data in inactive state. The data may have the size smaller than a threshold. That is, the data may be “Small Data”.

Obtaining may be understood as receiving, or retrieving, e.g., via the second link 142. In some examples, the first network node 111 may receive the first indication from the second network node 112. In other examples, the first network node 111 may retrieve the first indication from an internal memory.

By obtaining the first indication in this Action 301, the first network node 111 may be enabled to know if the wireless device 130 is configured with the one or more first configured grants. As a result, the first network node 111 may also be enabled to know in which cell the wireless device 130 in inactive state is located, as the configured grant may be understood to only be valid in a specific cell, here the first cell 121. As a consequence, the first network node 111 may understand that paging of the wireless device 130 may no longer be necessary. As a result, the first network node 111 may be enabled to configure the wireless device 130 to transmit data in inactive state in the next Action 302 in such a way that the time the wireless device 130 may need to be awake may be minimized, as will be explained in the next Action.

### Action 302

In this Action 302, the first network node 111 configures the wireless device 130 with one or more configured grants to transmit data in inactive state. The data has a size smaller than the threshold. That is, the data may be “Small Data”. The one or more configured grants are configured by the first network node 111 with a relation to one or more occasions to monitor a paging channel between the first network node 111 and the wireless device 130.

Configuring may be understood as sending an indication configuring. The configuring/sending may be performed, e.g., via the first link 141.

In some embodiments, the channel may be a Physical Downlink Control Channel (PDCCH).

The inactive state may be understood as a state wherein the wireless device 130 may monitor paging, e.g., it may monitor the PDCCH continuously for DL data transmissions. In particular examples, the inactive state may be understood to correspond to the RRC inactive state.

In some embodiments, the relation may be one of the following. According to a first option, the relation may be a fraction of the one or more occasions to monitor the paging channel. According to a second option, the relation may be a multiple of the one or more occasions to monitor the paging channel. That is, in a first group of examples, the CG periodicity may be aligned to the paging periodicity. This may be achieved in one of several ways. According to the first option and the second option, this may be achieved by specifying that the CG periodicity is given as a multiple or fraction of the paging periodicity. Examples of parameter settings may be e.g., N, N−1, . . . , 1, ½, ⅓, . . . , 1/K.

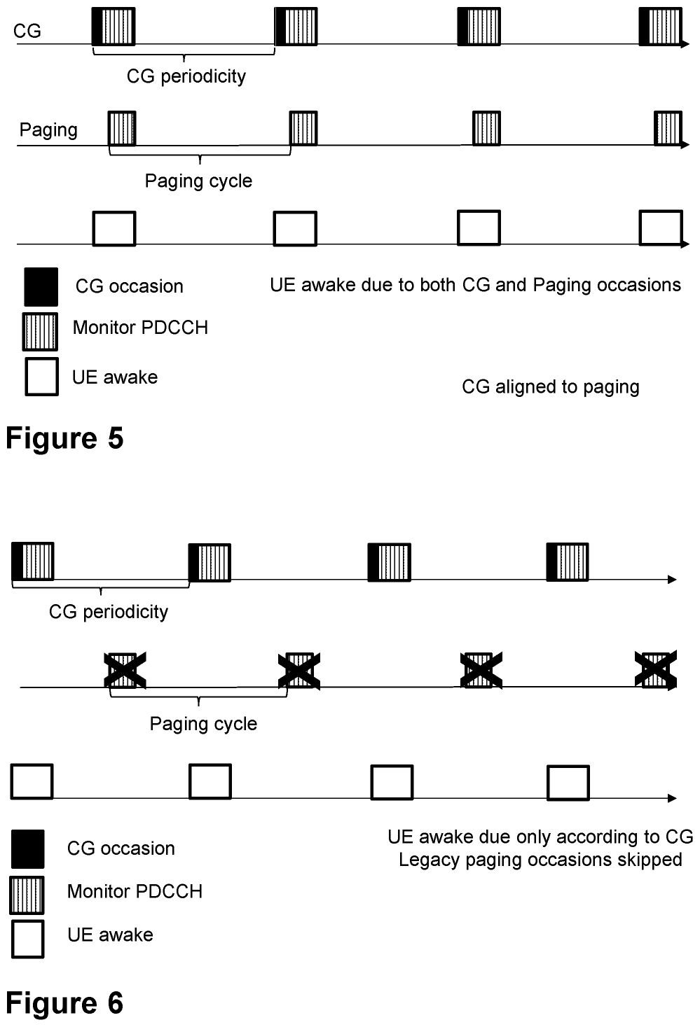

According to a third option, the relation may be an alignment in time with the one or more occasions to monitor the paging channel. In a second group of examples, the paging cycles and occasions may be aligned to the CG periodicity. In this case, the slots just after CG transmission occasions when the wireless device 130 anyway may be understood to need to monitor PDCCH for possible retransmissions or DL transmissions make the need for the normal paging cycles unnecessary. This may be understood to mean that the legacy or normal paging occasions as specified in 38.304, v. 16.3.0, or 38.213, v 16.4.0, may no longer need to be monitored, since the wireless device 130 may be reached during the time just after the CG transmission occasions. In this case, the wireless device 130 may monitor for P-RNTI for paging during the time when it may monitor for PDCCH after the CG transmission occasion. This may also be signaled in ConfiguredGrantConfig as a flag, e.g., “paging disabled” to signal that paging is not transmitted in paging occasions derived according to legacy procedure. An example of the resulting time the wireless device 130 may need to be awake when applying this group of examples is later, shown in FIG. 5.

According to a fourth option, the relation may be a subset of one or more first occasions to monitor the paging channel, already configured in the wireless device 130. That is, in another group of examples, for example when using a paging cycle with all or with only a subset of paging occasions aligned with the CG configurated periodicity, the latter when e.g., the CG grant occasions may be configured with a longer time periodicity compared to the paging cycle/occasions, and only every nth occasion may align.

According to a fifth option, the wireless device 130 may have been configured with one or more first configured grants, that is with one or more configured grants previously, or separately configured at the wireless device 130. In such cases, the first network node 111 may configured the wireless device 130 with an indicator of the relation that the one or more first configured grants may need to keep with the one or more occasions to monitor the paging channel. According to the fifth option, the relation may be, with the proviso that the wireless device 130 is configured with the one or more first configured grants to transmit data in inactive state, the data having a size smaller than the threshold, an instruction to one of: i) disable monitoring of the paging channel, and ii) monitor the paging channel during a subset of the configured one or more occasions to monitor the paging channel. According to the first option “i)” of the fifth option, in another approach of embodiments herein, paging may be disabled whenever CG-SDT may be configured for the wireless device 130, e.g., when CG-SDT may be in use. In other words, in one group of examples of embodiments herein, the wireless device 130 may not be required for monitoring of RAN-paging, as described in the background, when the wireless device 130 may have been configured with CG-SDT. That is, if for example, CG-SDT has been configured for the wireless device 130 in RRC_INACTIVE, the wireless device 130 may no longer be required to monitor paging as outlined in the background section. Neither may the first network node 111, e.g., a gNB attempt to reach the wireless device 130 using RAN-paging. Instead, the DL response to the UL CG-SDT transmission may provide an opportunity for the network to reach the wireless device 130 in DL. That is, the main purpose of the legacy paging procedure may be understood to be to be able to reach the wireless device 130 in DL. For the wireless device 130 in RRC_IDLE, or in RRC_INACTIVE for a RAN-paging, it may not be known to the network in which cell the wireless device 130 may be located, and in order to find the wireless device 130, the wireless device 130 may have to be paged in multiple cells or even tracking/registration areas. When CG-SDT is configured, it may be clear to the RAN in which cell the wireless device 130 is located since CG-SDT may be understood to be valid only in a specific cell, e.g., from the following agreement in RAN2 #112-e: “The configuration of configured grant resource for UE small data transmission is valid only in the same serving cell”. Therefore, when the wireless device 130 has been configured with CG-SDT there may be understood to be no need to page or try to locate in which cell the wireless device 130 may be located. An example is depicted later, in FIG. 6. In alternative examples of the above, according to the second option “ii)” of the fifth option, the part on the wireless device 130 not being required to monitor paging may be relaxed. The relaxation may, e.g., be that the wireless device 130 may be required only to monitor a subset of the paging occasions in order to catch error cases. In another group of examples, for example when using a paging cycle with all or with only a subset of paging occasions aligned with the CG configurated periodicity, the latter when e.g., the CG grant occasions may be configured with a longer time periodicity compared to the paging cycle/occasions, and only every nth occasion may align; the wireless device 130 may in such cases be configured to only monitor every n-th paging occasion, or alternatively, only paging occasions that may be determined to be aligned as described in accompanying groups of examples.

In some examples, the CG-SDT configuration may implicitly be released on the wireless device 130 side after a configurable number of unused CG-SDT occasions, at which point the wireless device 130 may start monitoring CN-paging again. In some embodiments, the relation may further specify that, with the proviso that a number of one or more first configured grants to transmit data in inactive state is skipped, the wireless device 130 is to monitor a subset of the configured one or more configured grants to transmit data in inactive state, e.g., for downlink transmissions from the first network node 111. To skip may be understood as to not transmit anything in that skipped configured grant. In any of the embodiments described herein, if the wireless device 130 may be allowed to skip a large number of the CG-SDT transmissions before the CG-SDT configuration may be released, the wireless device 130 may be required to still check a subset of the CG-SDT search spaces for downlink transmission. For example, if the wireless device 130 is allowed to skip up to 16 CG-SDT transmissions before the configuration is released, the wireless device 130 may be required to check the search space for DL transmissions in every 8th CG-SDT occasion.

In some embodiments, the configuring in this Action 302 may be performed via at least one of the following. According to a first option, the configuring in this Action 302 may be performed via a parameter in ConfiguredGrantConfig, e.g., a ConfiguredGrantConfig information element. This may be specified in ConfiguredGrantConfig as a new parameter overriding the legacy periodicity.

According to a second option, the configuring in this Action 302 may be performed via an offset with respect to the one or more occasions to monitor the paging channel. That is, the configuring in this Action 302 may be performed by specifying an offset, e.g., a small offset, compared to the paging occasions where the CG transmission may occur. The paging occasions may be calculated and monitored as specified in TS 38.304, v. 16.3.0, that is, the existing behavior. The offset may be calculated against a reference point, where the reference may be for example the first PDCCH monitoring occasion for paging in the PO, or alternatively, the last PDCCH monitoring occasion for paging during in the PO. The offset may point to a time after the paging occasion and the applicable reference point, e.g., a specific PDCCH monitoring occasion.

It may be understood that the relation may not need to be explicitly communicated to the wireless device 130, but the first network node 111 may ensure that the wireless device 130 is configured with the one or more configured grants keeping the relation. In some examples, however, the relation may be explicitly indicated to the wireless device 130, e.g., by indicating an offset with respect to the one or more occasions to monitor the paging channel, as just described. The relation may be understood to enable that the amount of time the wireless device 130 may need to be awake while in inactive state, may be reduced, in comparison to other configurations lacking the relation, while still enabling the wireless device 120 to transmit the data to the first network node 111.

In some embodiments, the configuring in this Action 302 of the one or more configured grants may be to be one of: a) before the one or more occasions to monitor the paging channel, and b) after the one or more occasions to monitor the paging channel. That is, the paging occasion may be either before the CG, in time, or vice versa. By having the paging before CG, it may be possible for the wireless device 130 to start transition to connected mode using the CG if the wireless device 130 is paged during the paging occasion. On the other hand, paging occasion after CG may be optimized in the sense that if the wireless device 130 is expected to monitor for PDCCH after the transmissions using CG in uplink, the PDCCH monitoring for CG may overlap with PDCCH monitoring for PO.

By the first network node 111 configuring the wireless device 130 with the one or more configured grants with the relation to the one or more occasions to monitor a paging channel, the amount of time the wireless device 130 may need to be awake while in inactive state, may be minimized, while the wireless device 130 may still be allowed to transmit small amounts of data. Hence, the wireless device 130 may be enabled to save energy consumption.

### Action 303

In this Action 303, the first network node 111 may refrain from paging the wireless device 130, based on the obtained first indication. Based on the obtained first indication may be understood to mean that with the proviso the first network node 111 may determine, as indicated by the first indication, that the wireless device 130 is configured with the one or more first configured grants, the first network node 111 may refrain from paging the wireless device 130.

By the first network node 111 refraining from paging the wireless device 130, the amount of time the wireless device 130 may need to be awake while in inactive state, may be minimized. Hence, the wireless device 130 may be enabled to save energy. Furthermore, by reducing the amount of signalling, the first network node 111 may reduce the amount of interference that may be produced and create less overhead, thereby improving the performance of the wireless communications network 100.

### Action 304

In this Action 304, the first network node 111 may buffer first data to be transmitted to the wireless device 130. The first network node 111 may buffer the first data based on the obtained first indication. Based on the obtained first indication may be understood to mean that with the proviso the first network node 111 may determine, as indicated by the first indication, that the wireless device 130 is configured with the one or more first configured grants, the first network node 111 may buffer the first data. First data may be understood to refer to a set of data to be transmitted to the wireless device 130. As explained earlier, in one group of examples of embodiments herein, the wireless device 130 may not be required for monitoring of RAN-paging, as described in the background, when the wireless device 130 may have been configured with CG-SDT. As of network implementation, the first network node 111 may therefore buffer any DL data until the subsequent CG-SDT transmission and multiplex the DL data with the acknowledgement and DL response to the uplink transmission.

By buffering the first data in this Action 304, the first network node 111 may be enabled to avoid having to unnecessarily wake up the wireless device 130, which may be understood to be in inactive state, to deliver the first data to it. Hence, the amount of time the wireless device 130 may need to be awake while in inactive state, may be minimized and the wireless device 130 may be enabled to save energy. Furthermore, by reducing the amount of signalling, the first network node 111 may reduce the amount of interference that may be produced and create less overhead, thereby improving the performance of the wireless communications network 100.

### Action 305

In this Action 305, based on the obtained first indication, the first network node 111 may send the buffered first data to the wireless device 130. The sending in this Action 305 of the buffered first data to the wireless device 130 may be in response to a subsequent configured grant to transmit data in inactive state, the data having a size smaller than the threshold. Based on the obtained first indication may be understood to mean that with the proviso the first network node 111 may determine, as indicated by the first indication, that the wireless device 130 is configured with the one or more first configured grants, the first network node 111 may send the first data it may have buffered to the wireless device 130.

Sending may be understood as transmitting, or providing, e.g., via the first link 141.

By sending the buffered first data in this Action 305, the first network node 111 may be enabled to avoid having to unnecessarily wake up the wireless device 130, while still being able to deliver the first data to it while the wireless device 130 may be in inactive state. Hence, the amount of time the wireless device 130 may need to be awake while in inactive state, may be minimized and the wireless device 130 may be enabled to save energy. Furthermore, by reducing the amount of signalling, the first network node 111 may reduce the amount of interference that may be produced and create less overhead, thereby improving the performance of the wireless communications network 100.

### Action 306

In some embodiments wherein the indication sent to configure the wireless device 130 in Action 302 may be a second indication, the first network node 111 may, in this Action 306, send a third indication to a second network node 112. The third indication may indicate that the wireless device 130 is configured with one or more configured grants to transmit data in inactive state.

Sending may be understood as transmitting, or providing, e.g., via the second link 142.

As explained earlier, in one group of examples of embodiments herein, the wireless device 130 may not be required for monitoring of RAN-paging, as described in the background, when the wireless device 130 may have been configured with CG-SDT. In addition, signaling may be introduced to inform the CN that the wireless device 130 is configured with CG-SDT and therefore may be understood to remain in the indicated first network node 111, e.g., gNB and/or cell, e.g., over NG-c from gNB/NG-RAN node to AMF. In this way, CN-paging may be adjusted to e.g., limit CN-paging to the CG-SDT cell to reduce overhead and interference.

If the wireless device 130 has moved to another gNB before it is configured with CG-SDT, signaling may be introduced over Xn from the current gNB, paging gNB, to inform the anchor gNB that the wireless device 130 is configured with CG-SDT, and hence it may be understood to be expected to remain in this cell.

In another group of examples of embodiments herein, which may be used in combination with the previous group of examples, the wireless device 130 may not be required to monitor for CN-paging. Signaling may be introduced to indicate to the CN that the wireless device 130 has been configured with CG-SDT in the indicated first network node 111, e.g., gNB/cell, e.g., over NG-c between gNB and AMF.

In alternative examples of the above, the signaling for informing the CN about the CG-SDT configuration of the wireless device 130 and remaining in this cell until further notice may be kept, but the part on the wireless device 130 not being required to monitor paging may be relaxed. The relaxation may, e.g., be that the wireless device 130 may be required only to monitor a subset of the paging occasions in order to catch error cases.

### Action 307

In some embodiments wherein the indication sent to configure the wireless device 130 in Action 302 may be a second indication, the first network node 111 may, in this Action 307, send a fourth indication to the second network node 112. The fourth indication may indicate that a configuration of one or more configured grants to transmit data in inactive state by the wireless device 130 has been cancelled or released.

Sending may be understood as transmitting, or providing, e.g., via the second link 142.

Corresponding signaling may also be introduced to that described in Action 306, in the group of examples of embodiments herein wherein the wireless device 130 may not be required for monitoring of RAN-paging. The corresponding signalling may be introduced, e.g., over NG-c from the second network node 112, e.g., the AMF, to gNB/NG-RAN node, to inform the CN, that is, for example, the AMF, of when the CG-SDT may have been released/cancelled, e.g., triggered by CG-SDT resources being unused, which may be an indication that the wireless device 130 may again be mobile and that it may again be required to monitor for paging. This CG-SDT state information may be stored in the CN, e.g., in the UE context in the second network node 112, e.g., the AMF. Xn signaling may also be introduced to inform the anchor gNB of when the CG-SDT may have been released/cancelled, e.g., triggered by CG-SDT resources being unused, which may be an indication that the wireless device 130 may again be mobile and that it may again be required to monitor for paging.

Corresponding signaling may also be introduced to that described in Action 306, in the group of examples of embodiments herein wherein the wireless device 130 may not be required for monitoring of CN-paging. The corresponding signalling may be introduced, e.g., over NG-c from the second network node 112, e.g., the AMF to gNB/NG-RAN node, to inform the CN, e.g., the AMF, of when the CG-SDT may have been released and/or cancelled, e.g., triggered by CG-SDT resources being unused, which may be an indication that the wireless device 130 may again be mobile and that it may again be required to monitor for paging. This CG-SDT state information may be stored in the CN, e.g., in the UE context in the second network node 112, e.g., the AMF. When the wireless device 130 may be in INACTIVE state, CN paging may typically be only used for error cases, that is, state mismatch. From the CN point of view, the wireless device 130 may be connected and handled by RAN and the first network node 111, e.g., the gNB. However, the wireless device 130 may still be required to monitor for CN paging at all times in case of error, which may be understood to add to the wireless device 130 power consumption and introduce problems on CN-paging and CG-SDT opportunity collisions. With the embodiments herein this may be omitted, and in of state mismatch resulting in that RAN/gNB may no longer reach the wireless device 130, the above signaling may be used to inform CN that the CG-SDT configuration has been released/cancelled and that the wireless device 130 may need again to monitor paging as of legacy operation, on the wireless device 130 side the CG-SDT configuration may implicitly be released after a configurable number of unused CG-SDT occasions, at which point the wireless device 130 may start monitoring CN-paging again.

Embodiments of a method, performed by a wireless device, such as the wireless device 130, will now be described with reference to the flowchart depicted in FIG. 4. The method may be understood to be for obtaining the configuration. The wireless device 130 operates in the wireless communications network 100.

Several embodiments are comprised herein. In some embodiments all the actions may be performed. In some embodiments, one or more actions may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. A non-limiting example of the method performed by the wireless device 130 is depicted in FIG. 4.

The detailed description of some of the following corresponds to the same references provided above, in relation to the actions described for the wireless device 130 and will thus not be repeated here. For example, in some embodiments, the wireless device 130 may be a 5G UE. In some embodiments, the first network node 111 may be a gNB. The second network node 112 may be another gNB, or an AMF.

### Action 401

In this Action 401, the wireless device 130 obtains the indication from the first network node 111. That is, the second indication. The indication may be understood to configure the wireless device 130 with the one or more configured grants to transmit data in inactive state. The data has the size smaller than the threshold. That is, the data may be “Small Data”. The one or more configured grants may be configured by the first network node 111 with the relation to the one or more occasions to monitor the paging channel between the first network node 111 and the wireless device 130.

Obtaining may be understood as receiving, or retrieving, e.g., via the first link 141.

In some embodiments, the channel may be the PDCCH.

In some embodiments, the relation may be one of: a) the fraction of the one or more occasions to monitor the paging channel, b) the multiple of the one or more occasions to monitor the paging channel, c) the alignment in time with the one or more occasions to monitor the paging channel, d) the subset of the one or more first occasions to monitor the paging channel, already configured in the wireless device 130, and e) with the proviso that the wireless device 130 is configured with the one or more first configured grants to transmit data in inactive state, the data having a size smaller than the threshold, the instruction to one of: i) disable monitoring of the paging channel, and ii) monitor the paging channel during the subset of the configured one or more occasions to monitor the paging channel.

In some embodiments, the obtaining in this Action 401 may be performed via at least one of: a) the parameter in ConfiguredGrantConfig, e.g., the ConfiguredGrantConfig information element, and b) the offset with respect to the one or more occasions to monitor the paging channel.

In some embodiments, the obtaining in this Action 402 of the indication configuring the wireless device 130 with the one or more configured grants may be to be one of: a) before the one or more occasions to monitor the paging channel, and b) after the one or more occasions to monitor the paging channel.

In some embodiments, the relation may further specify that, with the proviso that the number of one or more first configured grants to transmit data in inactive state is skipped, the wireless device 130 may be required to monitor the subset of the configured one or more configured grants to transmit data in inactive state, e.g., for downlink transmissions from the first network node 111.

### Action 402

In this Action 402, the wireless device 130 may receive the first data from the first network node 111 in response to the subsequent configured grant to transmit data in inactive state, the data having a size smaller than the threshold.

The receiving in this Action 402 may be performed, e.g., via the first link 141.

It may be understood that, according to the foregoing, a method performed by the second network node 112 may comprise receiving the second indication from the first network node 111 and/or receiving the third indication from the first network node 111.

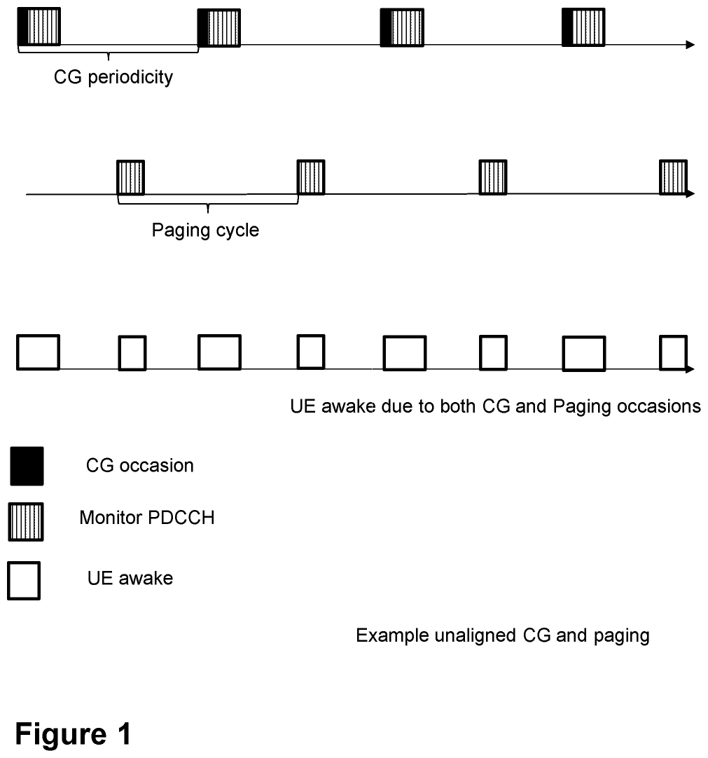

FIG. 5 is a schematic representation of an example of when the wireless device 130 may be awake when CG occasions may be aligned to paging occasions, according to embodiments herein. In the figure, CG opportunity is before the paging occasion, in another example the paging occasion may be after the CG opportunity. As may be concluded when comparing how often the wireless device 130 may be awake in this example, with that depicted for existing methods in FIG. 1, the wireless device 130, by being configured with the one or more configured grants aligned with the one or more occasions to monitor the paging channel, may be awake for a shorter period of time, thereby saving energy.

FIG. 6 is a schematic representation depicting an example of when the wireless device 130 may be awake when paging occasions may be skipped, according to another example of embodiments herein. As may be concluded when comparing how often the wireless device 130 may be awake in this example, with that depicted for existing methods in FIG. 1, the wireless device 130, by being configured to disable monitoring of the paging channel, may be awake for a shorter period of time, thereby saving energy.

Certain embodiments disclosed herein may provide one or more of the following technical advantage(s), which may be summarized as follows. Embodiments herein may enable that CG transmission occasions may be aligned with paging occasions thereby minimizing the time the wireless device 130 may need to be awake, which may be understood to translate into energy savings for the wireless device 130.

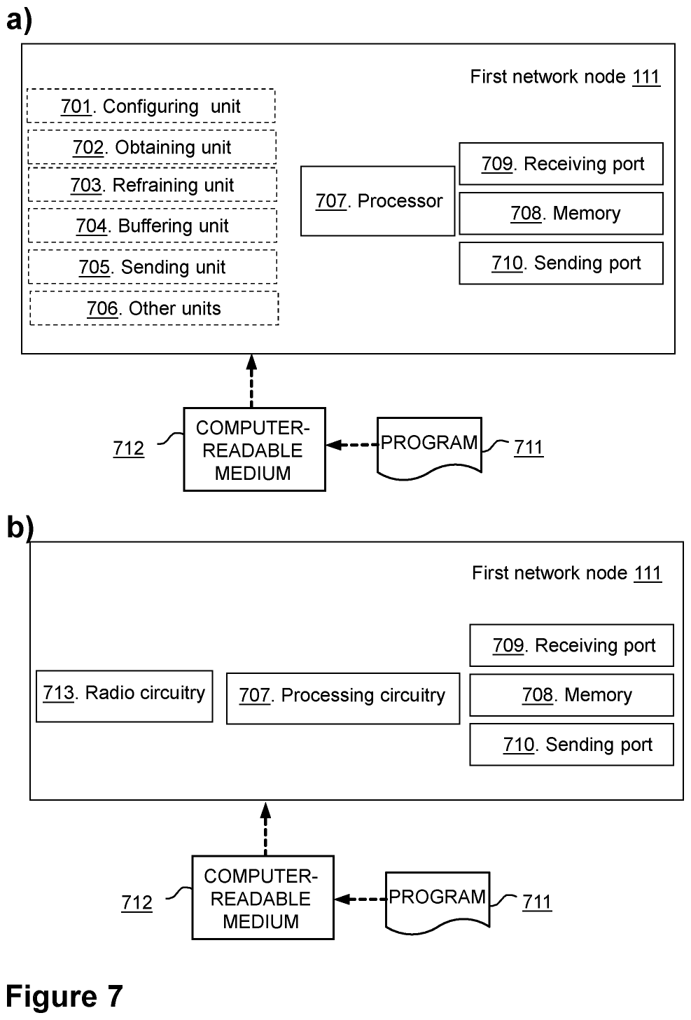

FIG. 7 depicts two different examples in panels a) and b), respectively, of the arrangement that the first network node 111 may comprise. In some embodiments, the first network node 111 may comprise the following arrangement depicted in FIG. 7a. The first network node 111 may be understood to be for configuring the wireless device 130. The first network node 111 is configured to operate in the wireless communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the wireless device 130, and will thus not be repeated here. For example, in some embodiments, the wireless device 130 may be a 5G UE. In some embodiments, the first network node 111 may be a gNB. The second network node 112 may be another gNB, or an AMF.

In FIG. 7, optional units are indicated with dashed boxes.

The first network node 111 may be configured to perform the configuring/sending of Action 302, e.g., by means of a configuring unit 701 within the first network node 111, configured to configure the wireless device 130 with the one or more configured grants to transmit data in inactive state. The data is configured to have the size smaller than the threshold. The one or more configured grants are configured by the first network node 111 with the relation to the one or more occasions to monitor the paging channel between the first network node 111 and the wireless device 130.

In some embodiments, the relation may be configured to be one of: a) the fraction of the one or more occasions to monitor the paging channel, b) the multiple of the one or more occasions to monitor the paging channel, c) the alignment in time with the one or more occasions to monitor the paging channel, d) the subset of the one or more first occasions to monitor the paging channel, already configured in the wireless device 130, and e) with the proviso that the wireless device 130 is configured with the one or more first configured grants to transmit data in inactive state, the data being configured to have the size smaller than the threshold, the instruction to one of: i) disable monitoring of the paging channel, and ii) monitor the paging channel during the subset of the configured one or more occasions to monitor the paging channel.

The configuring may be configured to be performed via at least one of: a) the parameter in the ConfiguredGrantConfig information element, and ii) the offset with respect to the one or more occasions to monitor the paging channel.

The configuring of the one or more configured grants may be configured to be one of: a) before the one or more occasions to monitor the paging channel, and b) after the one or more occasions to monitor the paging channel.

The channel may be configured to be a PDCCH.

In some embodiments, the first network node 111 may be configured to perform the obtaining of Action 301, e.g., by means of an obtaining unit 702, configured to obtain the first indication that the wireless device 130 is configured with the one or more first configured grants to transmit data in inactive state. The data may be configured to have the size smaller than the threshold.

In some embodiments, the first network node 111 may be configured to perform the refraining of Action 303, e.g., by means of the refraining unit 703, configured to refrain from paging the wireless device 130, based on the first indication configured to be obtained.

In some embodiments, the first network node 111 may be configured to perform the buffering of Action 304, e.g., by means of a buffering unit 704, configured to buffer the first data to be transmitted to the wireless device 130. This may be based on the first indication configured to be obtained.

In some embodiments, the first network node 111 may be configured to perform the sending of Action 305, e.g., by means of a sending unit 705, configured to send the buffered first data to the wireless device 130 in response to the subsequent configured grant to transmit data in inactive state. The data may be configured to have the size smaller than the threshold. This may be based on the first indication configured to be obtained.

In some examples, the indication may be a second indication, and the method may comprise, at least one of the following actions:

In some embodiments wherein the configuring may be configured to comprise sending the indication, and the indication may be configured to be the second indication, the first network node 111 may be configured to perform the sending of Action 306, e.g., by means of the sending unit 705, configured to send the third indication to the a second network node 112. The third indication may be configured to indicate that the wireless device 130 is configured with one or more configured grants to transmit data in inactive state.

In some embodiments wherein the configuring may be configured to comprise sending the indication, and the indication may be configured to be the second indication, the first network node 111 may be configured to perform the sending of Action 307, e.g., by means of the sending unit 705, configured to send the fourth indication to the second network node 112. The fourth indication may be configured to indicate that the configuration of the one or more configured grants to transmit data in inactive state by the wireless device 130 has been cancelled or released.

In some embodiments, the relation may be further configured to specify that, with the proviso that a number of one or more first configured grants to transmit data in inactive state is skipped, the wireless device 130 is to monitor a subset of the configured one or more configured grants to transmit data in inactive state for downlink transmissions from the first network node 111.

Other units 706 may be comprised in the first network node 111.

The embodiments herein in the first network node 111 may be implemented through one or more processors, such as a processor 707 in the first network node 111 depicted in FIG. 7a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first network node 111. One such carrier may be in the form of a CD ROM disc. It is however feasible with other data carriers such as a memory stick. The computer program code may furthermore be provided as pure program code on a server and downloaded to the first network node 111.

The first network node 111 may further comprise a memory 708 comprising one or more memory units. The memory 708 is arranged to be used to store obtained information, store data, configurations, schedulings, and applications etc. to perform the methods herein when being executed in the first network node 111.

In some embodiments, the first network node 111 may receive information from, e.g., the wireless device 130 and/or the second network node 112, through a receiving port 709. In some embodiments, the receiving port 709 may be, for example, connected to one or more antennas in first network node 111. In other embodiments, the first network node 111 may receive information from another structure in the wireless communications network 100 through the receiving port 709. Since the receiving port 709 may be in communication with the processor 707, the receiving port 709 may then send the received information to the processor 707. The receiving port 709 may also be configured to receive other information.

The processor 707 in the first network node 111 may be further configured to transmit or send information to e.g., the wireless device 130, the second network node 112, and/or another structure in the wireless communications network 100, through a sending port 710, which may be in communication with the processor 707, and the memory 708.

Those skilled in the art will also appreciate that the units 701-706 described above may refer to a combination of analog and digital circuits, and/or one or more processors configured with software and/or firmware, e.g., stored in memory, that, when executed by the one or more processors such as the processor 707, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 701-706 described above may be implemented as one or more applications running on one or more processors such as the processor 707.

Thus, the methods according to the embodiments described herein for the first network node 111 may be respectively implemented by means of a computer program 711 product, comprising instructions, i.e., software code portions, which, when executed on at least one processor 707, cause the at least one processor 707 to carry out the actions described herein, as performed by the first network node 111. The computer program 711 product may be stored on a computer-readable storage medium 712. The computer-readable storage medium 712, having stored thereon the computer program 711, may comprise instructions which, when executed on at least one processor 707, cause the at least one processor 707 to carry out the actions described herein, as performed by the first network node 111. In some embodiments, the computer-readable storage medium 712 may be a non-transitory computer-readable storage medium, such as a CD ROM disc, or a memory stick. In other embodiments, the computer program 711 product may be stored on a carrier containing the computer program 711 just described, wherein the carrier is one of an electronic signal, optical signal, radio signal, or the computer-readable storage medium 712, as described above.

The first network node 111 may comprise a communication interface configured to facilitate communications between the first network node 111 and other nodes or devices, e.g., the wireless device 130, the second network node 112, and/or another structure. The interface may, for example, include a transceiver configured to transmit and receive radio signals over an air interface in accordance with a suitable standard.

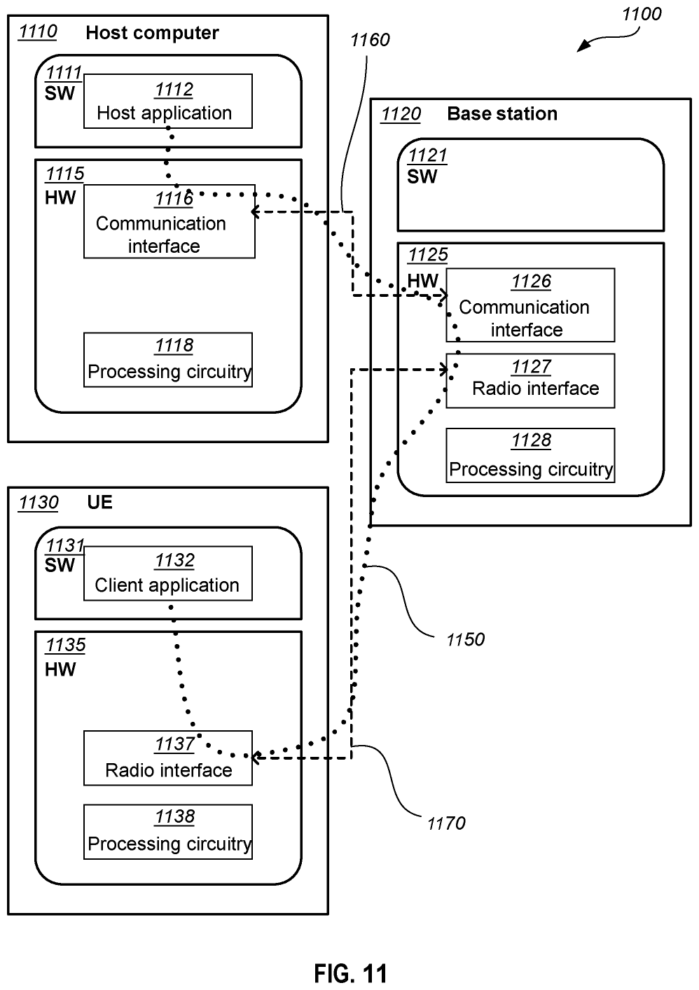

In other embodiments, the first network node 111 may comprise the following arrangement depicted in FIG. 7b. The first network node 111 may comprise a processing circuitry 707, e.g., one or more processors such as the processor 707, in the first network node 111 and the memory 708. The first network node 111 may also comprise a radio circuitry 713, which may comprise e.g., the receiving port 709 and the sending port 710. The processing circuitry 707 may be configured to, or operable to, perform the method actions according to FIG. 3, FIGS. 5-6 and/or FIGS. 11-15, in a similar manner as that described in relation to FIG. 7a. The radio circuitry 713 may be configured to set up and maintain at least a wireless connection with the wireless device 130, the second network node 112, and/or another structure. Circuitry may be understood herein as a hardware component.

Hence, embodiments herein also relate to the first network node 111 operative to operate in the wireless communications network 100. The first network node 111 may comprise the processing circuitry 707 and the memory 708, said memory 708 containing instructions executable by said processing circuitry 707, whereby the first network node 111 is further operative to perform the actions described herein in relation to the first network node 111, e.g., in FIG. 3, FIGS. 5-6 and/or FIGS. 11-15.

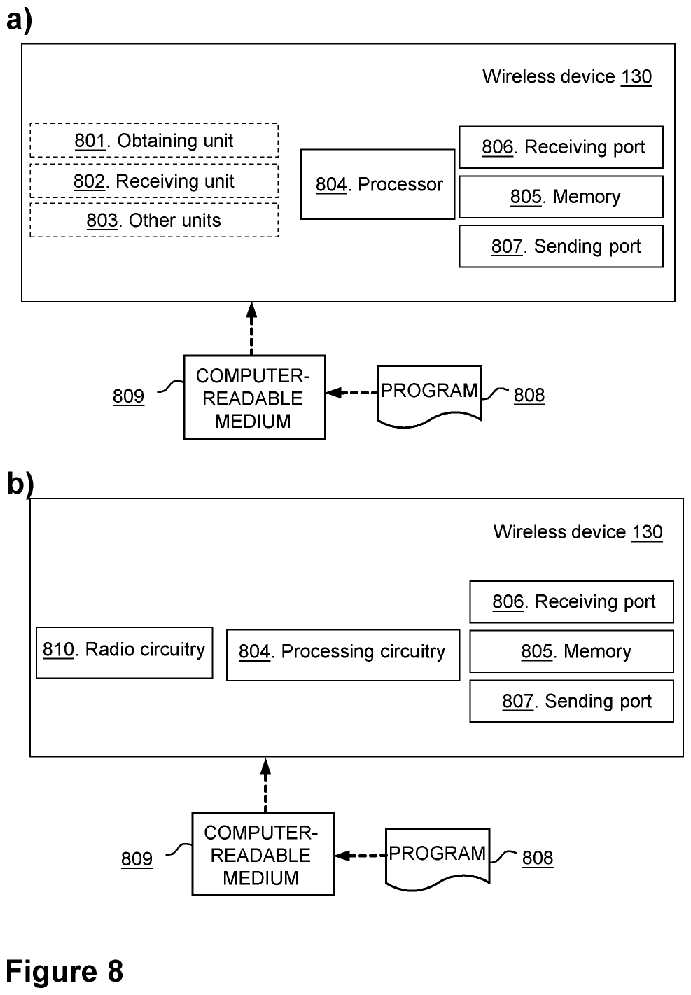

FIG. 8 depicts two different examples in panels a) and b), respectively, of the arrangement that the wireless device 130 may comprise. In some embodiments, the wireless device 130 may comprise the following arrangement depicted in FIG. 8a. The wireless device 130 may be understood to be for obtaining the configuration. The wireless device 130 is configured to operate in the wireless communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the wireless device 130, and will thus not be repeated here. For example, in some embodiments, the wireless device 130 may be a 5G UE. In some embodiments, the first network node 111 may be a gNB. The second network node 112 may be another gNB, or an AMF.

In FIG. 8, optional units are indicated with dashed boxes.

The wireless device 130 may be configured to perform the obtaining of Action 401, e.g., by means of an obtaining unit 801, configured to obtain the indication from the first network node 111, that is, the second indication. The indication is configured to configure the wireless device 130 with the one or more configured grants to transmit data in inactive state. The data is configured to have the size smaller than the threshold. The one or more configured grants are configured by the first network node 111 with the relation to the one or more occasions to monitor the paging channel between the first network node 111 and the wireless device 130.

In some embodiments, the relation may be configured to be one of: a) the fraction of the one or more occasions to monitor the paging channel, b) the multiple of the one or more occasions to monitor the paging channel, c) the alignment in time with the one or more occasions to monitor the paging channel, d) the subset of the one or more first occasions to monitor the paging channel, already configured in the wireless device 130, and e) with the proviso that the wireless device 130 is configured with the one or more first configured grants to transmit data in inactive state, the data being configured to have the size smaller than the threshold, the instruction to one of: i) disable monitoring of the paging channel, and ii) monitor the paging channel during the subset of the configured one or more occasions to monitor the paging channel.

The obtaining may be configured to be performed via at least one of: a) the parameter in the ConfiguredGrantConfig information element, and ii) the offset with respect to the one or more occasions to monitor the paging channel.

The obtaining of the indication configuring the wireless device 130 with the one or more configured grants may be configured to be one of: a) before the one or more occasions to monitor the paging channel, and b) after the one or more occasions to monitor the paging channel.

The channel may be configured to be the PDCCH.

The wireless device 130 may be configured to perform the receiving of Action 402, e.g., by means of a receiving unit 802, configured to receive the first data from the first network node 111 in response to the subsequent configured grant to transmit data in inactive state. The data may be configured to have the size smaller than the threshold.

In some embodiments, the relation may be further configured to specify that, with the proviso that a number of one or more first configured grants to transmit data in inactive state is skipped, the wireless device 130 is to monitor a subset of the configured one or more configured grants to transmit data in inactive state for downlink transmissions from the first network node 111.

Other units 803 may be comprised in the wireless device 130.

The embodiments herein in the wireless device 130 may be implemented through one or more processors, such as a processor 804 in the wireless device 130 depicted in FIG. 8a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the wireless device 130. One such carrier may be in the form of a CD ROM disc. It is however feasible with other data carriers such as a memory stick. The computer program code may furthermore be provided as pure program code on a server and downloaded to the wireless device 130.

The wireless device 130 may further comprise a memory 805 comprising one or more memory units. The memory 805 is arranged to be used to store obtained information, store data, configurations, schedulings, and applications etc. to perform the methods herein when being executed in the wireless device 130.

In some embodiments, the wireless device 130 may receive information from, e.g., the first network node 111, and/or the second network node 112, through a receiving port 806. In some embodiments, the receiving port 806 may be, for example, connected to one or more antennas in wireless device 130. In other embodiments, the wireless device 130 may receive information from another structure in the wireless communications network 100 through the receiving port 806. Since the receiving port 806 may be in communication with the processor 804, the receiving port 806 may then send the received information to the processor 804. The receiving port 806 may also be configured to receive other information.

The processor 804 in the wireless device 130 may be further configured to transmit or send information to e.g., the first network node 111, the second network node 112, and/or another structure in the wireless communications network 100, through a sending port 807, which may be in communication with the processor 804, and the memory 805.

Those skilled in the art will also appreciate that the units 801-802 described above may refer to a combination of analog and digital circuits, and/or one or more processors configured with software and/or firmware, e.g., stored in memory, that, when executed by the one or more processors such as the processor 804, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 801-802 described above may be implemented as one or more applications running on one or more processors such as the processor 804.

Thus, the methods according to the embodiments described herein for the wireless device 130 may be respectively implemented by means of a computer program 808 product, comprising instructions, i.e., software code portions, which, when executed on at least one processor 804, cause the at least one processor 804 to carry out the actions described herein, as performed by the wireless device 130. The computer program 808 product may be stored on a computer-readable storage medium 809. The computer-readable storage medium 809, having stored thereon the computer program 808, may comprise instructions which, when executed on at least one processor 804, cause the at least one processor 804 to carry out the actions described herein, as performed by the wireless device 130. In some embodiments, the computer-readable storage medium 809 may be a non-transitory computer-readable storage medium, such as a CD ROM disc, or a memory stick. In other embodiments, the computer program 808 product may be stored on a carrier containing the computer program 808 just described, wherein the carrier is one of an electronic signal, optical signal, radio signal, or the computer-readable storage medium 809, as described above.

The wireless device 130 may comprise a communication interface configured to facilitate communications between the wireless device 130 and other nodes or devices, e.g., the first network node 111, the second network node 112, and/or another structure. The interface may, for example, include a transceiver configured to transmit and receive radio signals over an air interface in accordance with a suitable standard.

In other embodiments, the wireless device 130 may comprise the following arrangement depicted in FIG. 8b. The wireless device 130 may comprise a processing circuitry 804, e.g., one or more processors such as the processor 804, in the wireless device 130 and the memory 805. The wireless device 130 may also comprise a radio circuitry 810, which may comprise e.g., the receiving port 806 and the sending port 807. The processing circuitry 804 may be configured to, or operable to, perform the method actions according to FIG. 4, FIG. 5-6 and/or FIGS. 11-15, in a similar manner as that described in relation to FIG. 8a. The radio circuitry 810 may be configured to set up and maintain at least a wireless connection with the first network node 111. Circuitry may be understood herein as a hardware component.

Hence, embodiments herein also relate to the wireless device 130 operative to operate in the wireless communications network 100. The wireless device 130 may comprise the processing circuitry 804 and the memory 805, said memory 805 containing instructions executable by said processing circuitry 804, whereby the wireless device 130 is further operative to perform the actions described herein in relation to the wireless device 130, e.g., in FIG. 4, FIG. 5-6 and/or FIGS. 11-15.

It may be understood that, according to the foregoing, the second network node 112 may comprise similar components to those of the first network node 111, with units configured to receiving the second indication from the first network node 111 and/or receiving the third indication from the first network node 111.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

When using the word “comprise” or “comprising” it shall be interpreted as non-limiting, i.e., meaning “consist at least of”.

A processor may be understood herein as a hardware component.

The embodiments herein are not limited to the above described preferred embodiments. Various alternatives, modifications and equivalents may be used. Therefore, the above embodiments should not be taken as limiting the scope of the invention.

### Examples Related to Embodiments Herein

Examples related to embodiments herein will now be described. More specifically, the following are examples related to a wireless device, such as the wireless device 130, e.g., a UE, and examples related to a node, such as the first network node 111, e.g., a gNB.

The first network node examples relate to FIG. 3, FIGS. 5-6, FIG. 7 and FIGS. 11-15. That is, the actions described as being performed by the first network node 111 may be performed by the arrangement described in FIG. 7.

A method, performed by a first network node, such as the first network node 111, is described herein. The method may be understood to be for configuring a wireless device, such as the wireless device 130. The first network node 111 may operate in the wireless communications network 100.

Several examples are comprised herein. In some examples all the actions may be performed. In some examples, one or more actions may be performed. It should be noted that the examples herein are not mutually exclusive. One or more examples may be combined, where applicable. All possible combinations are not described to simplify the description. Components from one example may be tacitly assumed to be present in another example and it will be obvious to a person skilled in the art how those components may be used in the other exemplary examples. Some actions may be performed in a different order than that shown FIG. 3. A non-limiting example of the method performed by the first network node 111 is depicted in FIG. 3.

In some examples, the first network node 111 may be a gNB. The second network node 112 may be another gNB, or an AMF.

In some examples, the wireless device 130 may be a 5G UE.
Configuring/Sending an indication configuring 302 the wireless device 130. The first network node 111 may be configured to perform this configuring/sending Action 302, e.g., by means of a configuring unit 701 within the first network node 111, configured to perform this action.

The configuring/sending may be performed, e.g., via the first link 141.

The configuring, or the indication, may configure the wireless device 130 with one or more configured grants. The one or more configured grants may be to transmit data, e.g., in inactive state. The data may have a size smaller than a threshold. That is, the data may be “Small Data”.

The one or more configured grants may be configured by the first network node 111 with a relation to one or more occasions. The one or more occasions may be to monitor a paging channel between the first network node 111 and the wireless device 130. In some examples, the channel may be a Physical Downlink Control Channel (PDCCH).

In some examples, the relation may be one of:
a fraction of the one or more occasions to monitor the paging channel,
a multiple of the one or more occasions to monitor the paging channel,
an alignment in time with the one or more occasions to monitor the paging channel,
a subset of one or more second occasions to monitor the paging channel, already configured in the wireless device 130, and
with the proviso that the wireless device 130 is configured with one or more first configured grants to transmit data in inactive state, the data having a size smaller than the threshold, an instruction to one of:
   i. disable monitoring of the paging channel, and
   ii. monitor the paging channel during a subset of the configured one or more occasions to monitor the paging channel.

In some examples, the configuring in this Action 302 may be performed via at least one of:
a parameter in ConfiguredGrantConfig, e.g., a ConfiguredGrantConfig information element, and
an offset with respect to the one or more occasions to monitor the paging channel.

In some examples, the configuring in this Action 302 of the one or more configured grants may be to be one of:
before the one or more occasions to monitor the paging channel, and
after the one or more occasions to monitor the paging channel.

In some examples, the relation may further specify that, with the proviso that a number of one or more first configured grants to transmit data in inactive state is skipped, the wireless device 130 is to monitor a subset of the configured one or more configured grants to transmit data in inactive state, e.g., for downlink transmissions from the first network node 111.

In some examples, the method may comprise one or more of the following actions:
Obtaining 301 a first indication. The first network node 111 may be configured to perform this obtaining action 301, e.g., by means of an obtaining unit 702, configured to perform this action.

The first indication may indicate that the wireless device 130 is configured with one or more first configured grants to transmit data in inactive state. The data may have a size smaller than the threshold.

Obtaining may be understood as receiving, or retrieving, e.g., via the first link 141.
Refraining 303 from paging the wireless device 130. The first network node 111 may be configured to perform this refraining action 303, e.g., by means of the refraining unit 703, configured to perform this action.

The refraining in this Action 303 may be based on the obtained first indication.

In some examples, the method may comprise, based on the obtained first indication, one or more of the following actions:
Buffering 304 first data. The first network node 111 may be configured to perform this buffering action 304, e.g., by means of a buffering unit 704, configured to perform this action.

The first data may be to be transmitted to the wireless device 130.
Sending 305 the buffered first data to the wireless device 130. The first network node 111 may be configured to perform this sending action 305, e.g., by means of a sending unit 705, configured to perform this action.

Sending may be understood as transmitting, or providing, e.g., via the first link 141.

The sending in this Action 305 of the buffered first data to the wireless device 130 may be in response to a subsequent configured grant to transmit data in inactive state, the data having a size smaller than the threshold.

In some examples, the indication may be a second indication, and the method may comprise, at least one of the following actions:
Sending 306 a third indication. The first network node 111 may be configured to perform this sending action 306, e.g., by means of the sending unit 705, configured to perform this action.

The sending in Action 306 of the third indication may be to the second network node 112. The third indication may indicate that the wireless device 130 is configured with one or more configured grants to transmit data in inactive state.

Sending may be understood as transmitting, or providing, e.g., via the second link 142.

Sending 307 a fourth indication. The first network node 111 may be configured to perform this sending action 307, e.g., by means of the sending unit 705, configured to perform this action.

The sending in Action 307 of the fourth indication may be to the second network node 112. The fourth indication may indicate that a configuration of one or more configured grants to transmit data in inactive state by the wireless device 130 has been cancelled or released.

Sending may be understood as transmitting, or providing, e.g., via the second link 142.

Examples of these actions and the indications are provided later in this document.

Other units 706 may be comprised in the first network node 111.

The first network node 111 may also be configured to communicate user data with a host application unit in a host computer 1110, e.g., via another link such as 1150.

In FIG. 7, optional units are indicated with dashed boxes.

The first network node 111 may comprise an arrangement as shown in FIG. 7 or in FIG. 11.

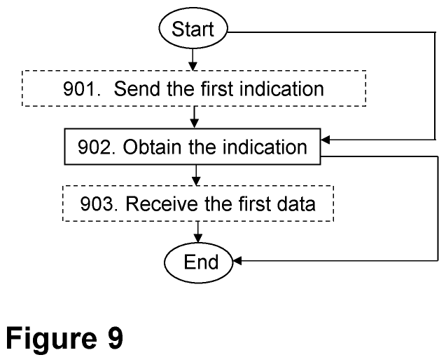

The wireless device examples relate to FIG. 9, FIGS. 5-6, FIG. 8 and FIGS. 11-15. That is, the actions described as being performed by the wireless device 130 may be performed by the arrangement described in FIG. 8.

A method, performed by a wireless device, such as the wireless device 130, is described herein. The method may be understood to be for obtaining a configuration. The wireless device 130 may operate in the wireless communications network 100.

Several examples are comprised herein. In some examples all the actions may be performed. In some examples, one or more actions may be performed. It should be noted that the examples herein are not mutually exclusive. One or more examples may be combined, where applicable. All possible combinations are not described to simplify the description. Components from one example may be tacitly assumed to be present in another example and it will be obvious to a person skilled in the art how those components may be used in the other exemplary examples. A non-limiting example of the method performed by the wireless device 130 is depicted in FIG. 9. Some actions may be performed in a different order than that shown in FIG. 9.

In some examples, the wireless device 130 may be a 5G UE.

In some examples, the first network node 111 may be a gNB. The second network node 112 may be another gNB, or an AMF.

Obtaining 902 an indication. The wireless device 130 may be configured to perform this obtaining action 902, e.g., by means of an obtaining unit 801, configured to perform this action.

The indication may be obtained from the first network node 111.

Obtaining may be understood as receiving, or retrieving, e.g., via the first link 141.

The indication may the configure the wireless device 130 with the one or more configured grants. The one or more configured grants may be to transmit data, e.g., in inactive state. The data may have a size smaller than a threshold. That is, the data may be “Small Data”.

The one or more configured grants may be configured by the first network node 111 with the relation to the one or more occasions. The one or more occasions may be to monitor the paging channel between the first network node 111 and the wireless device 130. In some examples, the channel may be the PDCCH.

In some examples, the relation may be one of:
the fraction of the one or more occasions to monitor the paging channel,
the multiple of the one or more occasions to monitor the paging channel,
the alignment in time with the one or more occasions to monitor the paging channel,
the subset of the one or more second occasions to monitor the paging channel, already configured in the wireless device 130, and
with the proviso that the wireless device 130 is configured with the one or more first configured grants to transmit data in inactive state, the data having a size smaller than the threshold, the instruction to one of:
   i. disable monitoring of the paging channel, and
   ii. monitor the paging channel during the subset of the configured one or more occasions to monitor the paging channel.

In some examples, the obtaining in this Action 902 may be performed via at least one of:
the parameter in ConfiguredGrantConfig, e.g., the ConfiguredGrantConfig information element, and
the offset with respect to the one or more occasions to monitor the paging channel.

In some examples, the obtaining in this Action 902 of the indication configuring the wireless device 130 with the one or more configured grants may be to be one of:
before the one or more occasions to monitor the paging channel, and
after the one or more occasions to monitor the paging channel.

In some examples, the relation may further specify that, with the proviso that the number of one or more first configured grants to transmit data in inactive state is skipped, the wireless device 130 is to monitor the subset of the configured one or more configured grants to transmit data in inactive state, e.g., for downlink transmissions from the first network node 111.

In some examples, the method may comprise one or more of the following actions:
Sending 901 the first indication. The wireless device 130 may be configured to perform this sending action 901, e.g., by means of a sending unit 802, configured to perform this action.

The sending of the first indication may be to the first network node 111.

The first indication may indicate that the wireless device 130 is configured with the one or more first configured grants to transmit data in inactive state. The data may have a size smaller than the threshold. The wireless device 130 may stop receiving paging from the first network node 111 after sending the first indication.

Sending may be understood as transmitting, or providing, e.g., via the first link 141.

In some examples, the method may comprise, based on the sent first indication, one or more of the following actions:
Receiving 903 the first data from the first network node 111. The wireless device 130 may be configured to perform this receiving action 903, e.g., by means of a receiving unit 803, configured to perform this action.

Sending may be understood as transmitting, or providing, e.g., via the first link 141.

The receiving in this Action 903 of the first data from the first network node 111 may be in response to the subsequent configured grant to transmit data in inactive state, the data having a size smaller than the threshold.

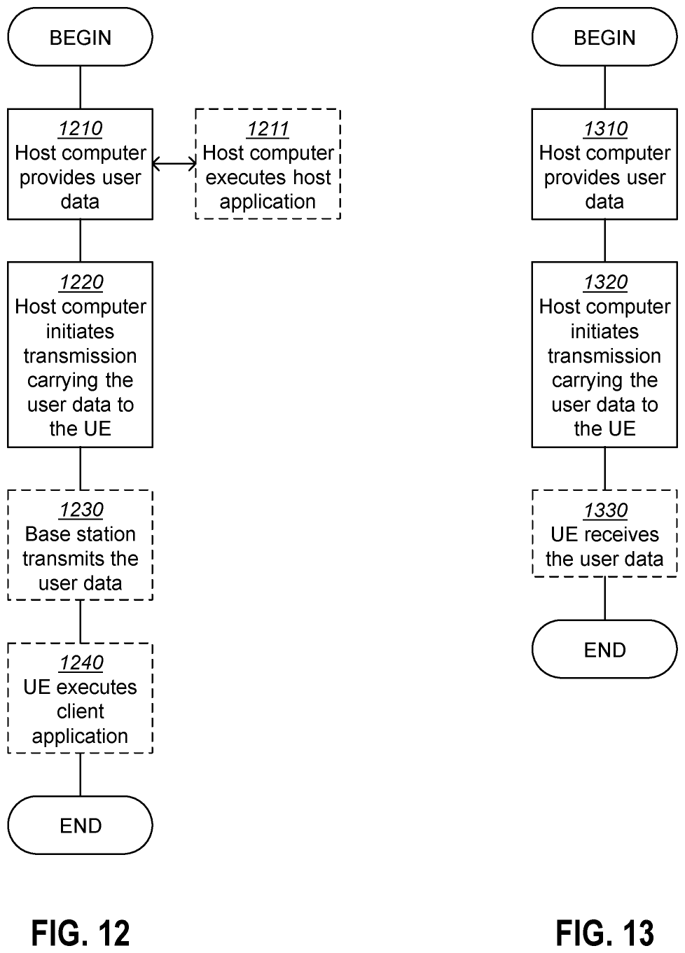

Examples of these actions and the indications are provided later in this document, e.g., in FIGS. 12-14.

Other units 804 may be comprised in the wireless device 130.

The wireless device 130 may also be configured to communicate user data with a host application unit in a host computer 1110, e.g., via another link such as 1150.

In FIG. 8, optional units are indicated with dashed boxes.

The wireless device 130 may comprise an arrangement as shown in FIG. 8 or in FIG. 11.

### Selected Examples

Example 1. A method performed by a first network node (111), the method being for configuring a wireless device (130), the first network node (111) operating in the wireless communications network (100), the method comprising:
configuring/sending an indication configuring (302), the wireless device (130) with one or more configured grants to transmit data in inactive state, the data having a size smaller than a threshold, the one or more configured grants being configured by the first network node (111) with a relation to one or more occasions to monitor a paging channel between the first network node (111) and the wireless device (130).

Example 2. The method according to example 1, wherein the relation is one of:
a fraction of the one or more occasions to monitor the paging channel,
a multiple of the one or more occasions to monitor the paging channel,
an alignment in time with the one or more occasions to monitor the paging channel,
a subset of one or more second occasions to monitor the paging channel, already configured in the wireless device (130), and
with the proviso that the wireless device (130) is configured with one or more first configured grants to transmit data in inactive state, the data having a size smaller than the threshold, an instruction to one of:
   i. disable monitoring of the paging channel, and
   ii. monitor the paging channel during a subset of the configured one or more occasions to monitor the paging channel.

Example 3. The method according to any of examples 1-2, wherein the configuring (302) is
a parameter in a ConfiguredGrantConfig information element,
an offset with respect to the one or more occasions to monitor the paging channel.

Example 4. The method according to any of examples 1-3, wherein the configuring (302) of the one or more configured grants is to be one of:
before the one or more occasions to monitor the paging channel, and
after the one or more occasions to monitor the paging channel.

Example 5. The method according to any of examples 1-4, wherein the channel is a Physical Downlink Control Channel, PDCCH.

Example 6. The method according to any of examples 1-5, wherein the method further comprises:
obtaining (301) a first indication that the wireless device (130) is configured with one or more first configured grants to transmit data in inactive state, the data having the size smaller than the threshold, and
refraining (303) from paging the wireless device (130), based on the obtained first indication.

Example 7. The method according to example 6, wherein the method further comprises, based on the obtained first indication:
buffering (304) first data to be transmitted to the wireless device (130), and
sending (305) the buffered first data to the wireless device (130) in response to a subsequent configured grant to transmit data in inactive state, the data having a size smaller than the threshold.

Example 8. The method according to any of examples 1-7, wherein the indication is a second indication, and wherein method further comprises at least one of:
sending (306) a third indication to a second network node (112), the third indication indicating that the wireless device (130) is configured with one or more configured grants to transmit data in inactive state, and
sending (307) a fourth indication to the second network node (112), the fourth indication indicating that a configuration of one or more configured grants to transmit data in inactive state by the wireless device (130) has been cancelled or released.

Example 9. The method according to any of examples 2 and any of examples 3-8, wherein the relation further specifies that with the proviso that a number of one or more first configured grants to transmit data in inactive state is skipped, the wireless device (130) is to monitor a subset of the configured one or more configured grants to transmit data in inactive state for downlink transmissions from the first network node (111).

Example 10. A method performed by a wireless device (130), the method being for obtaining a configuration, the wireless device (130) operating in the wireless communications network (100), the method comprising:
obtaining (902) an indication from a first network node (111), the indication configuring the wireless device (130) with one or more configured grants to transmit data in inactive state, the data having a size smaller than a threshold, the one or more configured grants being configured by the first network node (111) with a relation to one or more occasions to monitor a paging channel between the first network node (111) and the wireless device (130).

Example 11. The method according to example 10, wherein the relation is one of:
a fraction of the one or more occasions to monitor the paging channel,
a multiple of the one or more occasions to monitor the paging channel,
an alignment in time with the one or more occasions to monitor the paging channel,
a subset of one or more second occasions to monitor the paging channel, already configured in the wireless device (130), and
with the proviso that the wireless device (130) is configured with one or more first configured grants to transmit data in inactive state, the data having a size smaller than the threshold, an instruction to one of:
   i. disable monitoring of the paging channel, and
   ii. monitor the paging channel during a subset of the configured one or more occasions to monitor the paging channel.

Example 12. The method according to any of examples 10-11, wherein the obtaining (902) is
a parameter in a ConfiguredGrantConfig information element,
an offset with respect to the one or more occasions to monitor the paging channel.

Example 13. The method according to any of examples 10-12, wherein the obtaining (902) of the indication configuring the wireless device (130) with one or more configured grants is to be one of:
before the one or more occasions to monitor the paging channel, and
after the one or more occasions to monitor the paging channel.

Example 14. The method according to any of examples 10-13, wherein the channel is a Physical Downlink Control Channel, PDCCH.

Example 15. The method according to any of examples 10-14, wherein the method further comprises:
sending (901) a first indication to the first network node (111), the first indication indicating that the wireless device (130) is configured with one or more first configured grants to transmit data in inactive state, the data having a size smaller than the threshold, and wherein the wireless device (130) stops receiving paging from the first network node (111), after sending the first indication.

Example 16. The method according to example 15, wherein the method further comprises, based on the sent first indication:
receiving (903) first data from the first network node (111) in response to a subsequent configured grant to transmit data in inactive state, the data having a size smaller than the threshold.

Example 17. The method according to any of examples 11 and any of examples 12-16, wherein the relation further specifies that with the proviso that a number of one or more first configured grants to transmit data in inactive state is skipped, the wireless device (130) is to monitor a subset of the configured one or more configured grants to transmit data in inactive state for downlink transmissions from the first network node (111).

### Further Extensions And Variations

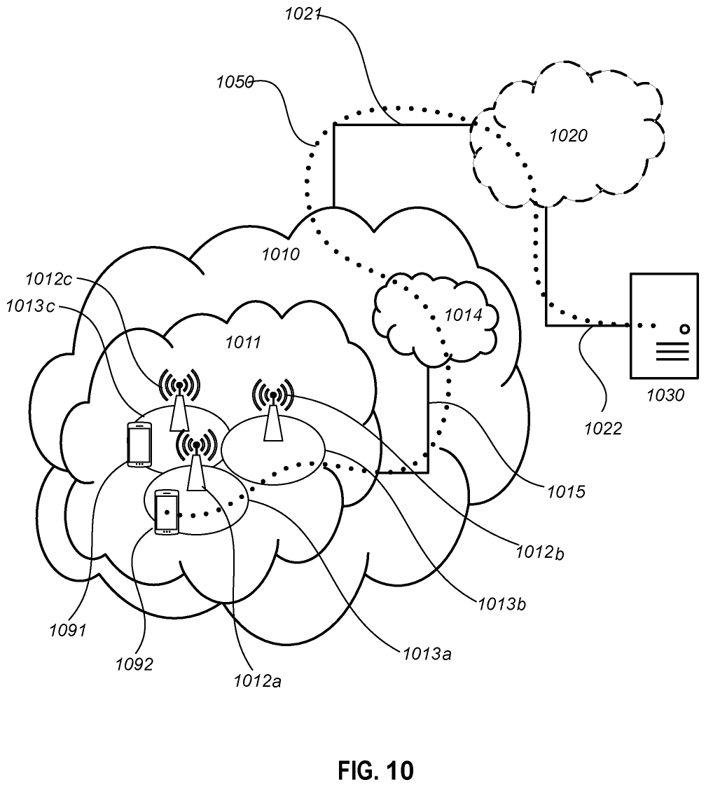

### FIG. 10: Telecommunication Network Connected Via an Intermediate Network to a Host Computer in Accordance with Some Embodiments

With reference to FIG. 10, in accordance with an embodiment, a communication system includes telecommunication network 1010 such as the wireless communications network 100, for example, a 3GPP-type cellular network, which comprises access network 1011, such as a radio access network, and core network 1014. Access network 1011 comprises a plurality of network nodes such as any or both of the first network node 111 and the second network node 112. For example, base stations 1012a, 1012b, 1012c, such as NBs, eNBs, gNBs or other types of wireless access points, each defining a corresponding coverage area 1013a, 1013b, 1013c. Each base station 1012a, 1012b, 1012c is connectable to core network 1014 over a wired or wireless connection 1015. A plurality of wireless devices, such as the wireless device 130, are comprised in the wireless communications network 100. In FIG. 10, a first UE 1091 located in coverage area 1013c is configured to wirelessly connect to, or be paged by, the corresponding base station 1012c. A second UE 1092 in coverage area 1013a is wirelessly connectable to the corresponding base station 1012a. While a plurality of UEs 1091, 1092 are illustrated in this example, the disclosed embodiments are equally applicable to a situation where a sole UE is in the coverage area or where a sole UE is connecting to the corresponding base station 1012. Any of the UEs 1091, 1092 are examples of the wireless device 130.

Telecommunication network 1010 is itself connected to host computer 1030, which may be embodied in the hardware and/or software of a standalone server, a cloud-implemented server, a distributed server or as processing resources in a server farm. Host computer 1030 may be under the ownership or control of a service provider, or may be operated by the service provider or on behalf of the service provider. Connections 1021 and 1022 between telecommunication network 1010 and host computer 1030 may extend directly from core network 1014 to host computer 1030 or may go via an optional intermediate network 1020. Intermediate network 1020 may be one of, or a combination of more than one of, a public, private or hosted network; intermediate network 1020, if any, may be a backbone network or the Internet; in particular, intermediate network 1020 may comprise two or more sub-networks (not shown).

The communication system of FIG. 10 as a whole enables connectivity between the connected UEs 1091, 1092 and host computer 1030. The connectivity may be described as an over-the-top (OTT) connection 1050. Host computer 1030 and the connected UEs 1091, 1092 are configured to communicate data and/or signaling via OTT connection 1050, using access network 1011, core network 1014, any intermediate network 1020 and possible further infrastructure (not shown) as intermediaries. OTT connection 1050 may be transparent in the sense that the participating communication devices through which OTT connection 1050 passes are unaware of routing of uplink and downlink communications. For example, base station 1012 may not or need not be informed about the past routing of an incoming downlink communication with data originating from host computer 1030 to be forwarded (e.g., handed over) to a connected UE 1091. Similarly, base station 1012 need not be aware of the future routing of an outgoing uplink communication originating from the UE 1091 towards the host computer 1030.

In relation to FIGS. 11, 12, 13, 14, and 15, which are described next, it may be understood that a UE is an example of the wireless device 130, and that any description provided for the UE equally applies to the wireless device 130. It may be also understood that the base station is an example of any or both of the first network node 111 and the second network node 112, and that any description provided for the base station equally applies to any or both of the first network node 111 and the second network node 112.

### FIG. 11: Host Computer Communicating Via a Base Station with a User Equipment Over a Partially Wireless Connection in Accordance with Some Embodiments

Example implementations, in accordance with an embodiment, of the wireless device 130, e.g., a UE, the first network node 111, e.g., a base station and host computer discussed in the preceding paragraphs will now be described with reference to FIG. 11. In communication system 1100, such as the wireless communications network 100, host computer 1110 comprises hardware 1115 including communication interface 1116 configured to set up and maintain a wired or wireless connection with an interface of a different communication device of communication system 1100. Host computer 1110 further comprises processing circuitry 1118, which may have storage and/or processing capabilities. In particular, processing circuitry 1118 may comprise one or more programmable processors, application-specific integrated circuits, field programmable gate arrays or combinations of these (not shown) adapted to execute instructions. Host computer 1110 further comprises software 1111, which is stored in or accessible by host computer 1110 and executable by processing circuitry 1118. Software 1111 includes host application 1112. Host application 1112 may be operable to provide a service to a remote user, such as UE 1130 connecting via OTT connection 1150 terminating at UE 1130 and host computer 1110. In providing the service to the remote user, host application 1112 may provide user data which is transmitted using OTT connection 1150.

Communication system 1100 further includes the first network node 111, exemplified in FIG. 11 as a base station 1120 provided in a telecommunication system and comprising hardware 1125 enabling it to communicate with host computer 1110 and with UE 1130. Hardware 1125 may include communication interface 1126 for setting up and maintaining a wired or wireless connection with an interface of a different communication device of communication system 1100, as well as radio interface 1127 for setting up and maintaining at least wireless connection 1170 with the wireless device 130, exemplified in FIG. 11 as a UE 1130 located in a coverage area (not shown in FIG. 11) served by base station 1120. Communication interface 1126 may be configured to facilitate connection 1160 to host computer 1110. Connection 1160 may be direct or it may pass through a core network (not shown in FIG. 11) of the telecommunication system and/or through one or more intermediate networks outside the telecommunication system. In the embodiment shown, hardware 1125 of base station 1120 further includes processing circuitry 1128, which may comprise one or more programmable processors, application-specific integrated circuits, field programmable gate arrays or combinations of these (not shown) adapted to execute instructions. Base station 1120 further has software 1121 stored internally or accessible via an external connection.

Communication system 1100 further includes UE 1130 already referred to. Its hardware 1135 may include radio interface 1137 configured to set up and maintain wireless connection 1170 with a base station serving a coverage area in which UE 1130 is currently located. Hardware 1135 of UE 1130 further includes processing circuitry 1138, which may comprise one or more programmable processors, application-specific integrated circuits, field programmable gate arrays or combinations of these (not shown) adapted to execute instructions. UE 1130 further comprises software 1131, which is stored in or accessible by UE 1130 and executable by processing circuitry 1138. Software 1131 includes client application 1132. Client application 1132 may be operable to provide a service to a human or non-human user via UE 1130, with the support of host computer 1110. In host computer 1110, an executing host application 1112 may communicate with the executing client application 1132 via OTT connection 1150 terminating at UE 1130 and host computer 1110. In providing the service to the user, client application 1132 may receive request data from host application 1112 and provide user data in response to the request data. OTT connection 1150 may transfer both the request data and the user data. Client application 1132 may interact with the user to generate the user data that it provides.

It is noted that host computer 1110, base station 1120 and UE 1130 illustrated in FIG. 11 may be similar or identical to host computer 1030, one of base stations 1012a, 1012b, 1012c and one of UEs 1091, 1092 of FIG. 10, respectively. This is to say, the inner workings of these entities may be as shown in FIG. 11 and independently, the surrounding network topology may be that of FIG. 10.

In FIG. 11, OTT connection 1150 has been drawn abstractly to illustrate the communication between host computer 1110 and UE 1130 via base station 1120, without explicit reference to any intermediary devices and the precise routing of messages via these devices. Network infrastructure may determine the routing, which it may be configured to hide from UE 1130 or from the service provider operating host computer 1110, or both. While OTT connection 1150 is active, the network infrastructure may further take decisions by which it dynamically changes the routing (e.g., on the basis of load balancing consideration or reconfiguration of the network).

Wireless connection 1170 between UE 1130 and base station 1120 is in accordance with the teachings of the embodiments described throughout this disclosure. One or more of the various embodiments improve the performance of OTT services provided to UE 1130 using OTT connection 1150, in which wireless connection 1170 forms the last segment. More precisely, the teachings of these embodiments may improve the latency, signalling overhead, and service interruption and thereby provide benefits such as reduced user waiting time, better responsiveness and extended battery lifetime.

A measurement procedure may be provided for the purpose of monitoring data rate, latency and other factors on which the one or more embodiments improve. There may further be an optional network functionality for reconfiguring OTT connection 1150 between host computer 1110 and UE 1130, in response to variations in the measurement results. The measurement procedure and/or the network functionality for reconfiguring OTT connection 1150 may be implemented in software 1111 and hardware 1115 of host computer 1110 or in software 1131 and hardware 1135 of UE 1130, or both. In embodiments, sensors (not shown) may be deployed in or in association with communication devices through which OTT connection 1150 passes; the sensors may participate in the measurement procedure by supplying values of the monitored quantities exemplified above, or supplying values of other physical quantities from which software 1111, 1131 may compute or estimate the monitored quantities. The reconfiguring of OTT connection 1150 may include message format, retransmission settings, preferred routing etc.; the reconfiguring need not affect base station 1120, and it may be unknown or imperceptible to base station 1120. Such procedures and functionalities may be known and practiced in the art. In certain embodiments, measurements may involve proprietary UE signaling facilitating host computer 1110's measurements of throughput, propagation times, latency and the like. The measurements may be implemented in that software 1111 and 1131 causes messages to be transmitted, in particular empty or ‘dummy’ messages, using OTT connection 1150 while it monitors propagation times, errors etc.

The first network node embodiments relate to FIG. 3, FIGS. 5-6, FIG. 7 and FIGS. 11-15.

The first network node 111 may also be configured to communicate user data with a host application unit in a host computer 1110, e.g., via another link such as 1150.

The first network node 111 may comprise an arrangement as shown in FIG. 7 or in FIG. 11.

The wireless device embodiments relate to FIG. 4, FIGS. 5-6, FIG. 8 and FIGS. 11-15.

The wireless device 130 may also be configured to communicate user data with a host application unit in a host computer 1110, e.g., via another link such as 1150.

The wireless device 130 may comprise an arrangement as shown in FIG. 8 or in FIG. 11.

### FIG. 12: Methods Implemented in a Communication System Including a Host Computer, a Base Station and a User Equipment in Accordance with Some Embodiments

FIG. 12 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 12 will be included in this section. In step 1210, the host computer provides user data. In substep 1211 (which may be optional) of step 1210, the host computer provides the user data by executing a host application. In step 1220, the host computer initiates a transmission carrying the user data to the UE. In step 1230 (which may be optional), the base station transmits to the UE the user data which was carried in the transmission that the host computer initiated, in accordance with the teachings of the embodiments described throughout this disclosure. In step 1240 (which may also be optional), the UE executes a client application associated with the host application executed by the host computer.

### FIG. 13: Methods Implemented in a Communication System Including a Host Computer, a Base Station and a User Equipment in Accordance with Some Embodiments

FIG. 13 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 13 will be included in this section. In step 1310 of the method, the host computer provides user data. In an optional substep (not shown) the host computer provides the user data by executing a host application. In step 1320, the host computer initiates a transmission carrying the user data to the UE. The transmission may pass via the base station, in accordance with the teachings of the embodiments described throughout this disclosure. In step 1330 (which may be optional), the UE receives the user data carried in the transmission.

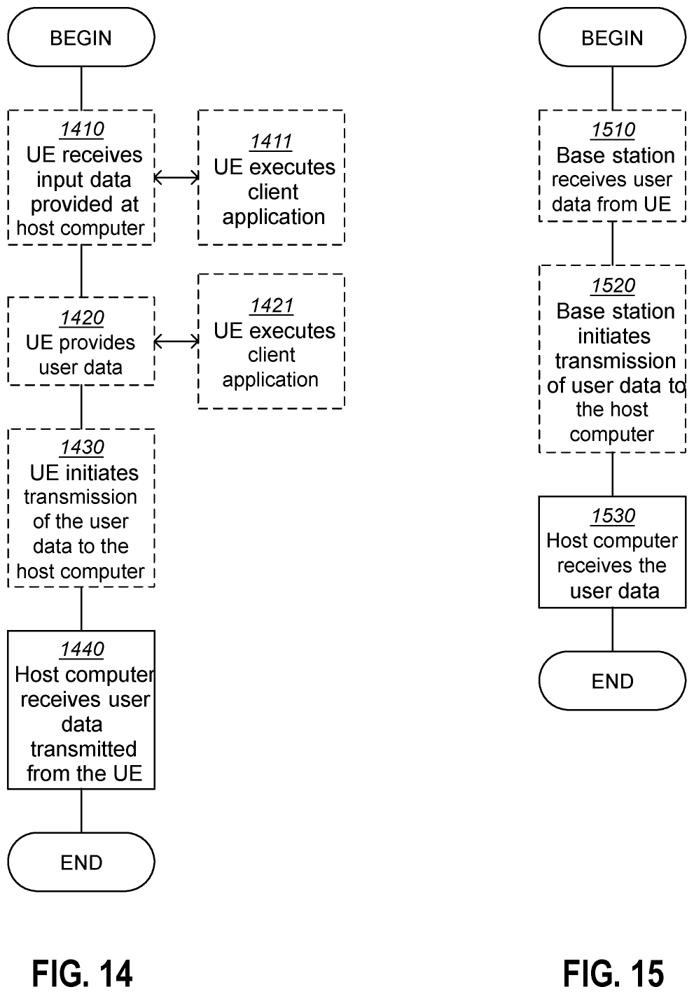

### FIG. 14: Methods Implemented in a Communication System Including a Host Computer, a Base Station and a User Equipment in Accordance with Some Embodiments

FIG. 14 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 14 will be included in this section. In step 1410 (which may be optional), the UE receives input data provided by the host computer. Additionally or alternatively, in step 1420, the UE provides user data. In substep 1421 (which may be optional) of step 1420, the UE provides the user data by executing a client application. In substep 1411 (which may be optional) of step 1410, the UE executes a client application which provides the user data in reaction to the received input data provided by the host computer. In providing the user data, the executed client application may further consider user input received from the user. Regardless of the specific manner in which the user data was provided, the UE initiates, in substep 1430 (which may be optional), transmission of the user data to the host computer. In step 1440 of the method, the host computer receives the user data transmitted from the UE, in accordance with the teachings of the embodiments described throughout this disclosure.

### FIG. 15: Methods Implemented in a Communication System Including a Host Computer, a Base Station and a User Equipment in Accordance with Some Embodiments

FIG. 15 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 15 will be included in this section. In step 1510 (which may be optional), in accordance with the teachings of the embodiments described throughout this disclosure, the base station receives user data from the UE. In step 1520 (which may be optional), the base station initiates transmission of the received user data to the host computer. In step 1530 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### Further Numbered Embodiments

1. A base station configured to communicate with a user equipment (UE), the base station comprising a radio interface and processing circuitry configured to perform one or more of the actions described herein as performed by the first network node 111.

5. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform one or more of the actions described herein as performed by the first network node 111.

6. The communication system of embodiment 5, further including the base station.

7. The communication system of embodiment 6, further including the UE, wherein the UE is configured to communicate with the base station.

8. The communication system of embodiment 7, wherein:
the processing circuitry of the host computer is configured to execute a host application, thereby providing the user data; and
the UE comprises processing circuitry configured to execute a client application associated with the host application.

11. A method implemented in a base station, comprising one or more of the actions described herein as performed by the first network node 111.

15. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs one or more of the actions described herein as performed by the first network node 111.

16. The method of embodiment 15, further comprising:
at the base station, transmitting the user data.

17. The method of embodiment 16, wherein the user data is provided at the host computer by executing a host application, the method further comprising:
at the UE, executing a client application associated with the host application.

21. A user equipment (UE) configured to communicate with a base station, the UE comprising a radio interface and processing circuitry configured to perform one or more of the actions described herein as performed by the wireless device 130.

25. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's processing circuitry configured to perform one or more of the actions described herein as performed by the wireless device 130.

26. The communication system of embodiment 25, further including the UE.

27. The communication system of embodiment 26, wherein the cellular network further includes a base station configured to communicate with the UE.

28. The communication system of embodiment 26 or 27, wherein:
the processing circuitry of the host computer is configured to execute a host application, thereby providing the user data; and
the UE's processing circuitry is configured to execute a client application associated with the host application.

31. A method implemented in a user equipment (UE), comprising one or more of the actions described herein as performed by the wireless device 130.

35. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs one or more of the actions described herein as performed by the wireless device 130.

36. The method of embodiment 35, further comprising:
at the UE, receiving the user data from the base station.

41. A user equipment (UE) configured to communicate with a base station, the UE comprising a radio interface and processing circuitry configured to perform one or more of the actions described herein as performed by the wireless device 130.

45. A communication system including a host computer comprising:
a communication interface configured to receive user data originating from a transmission from a user equipment (UE) to a base station,
wherein the UE comprises a radio interface and processing circuitry, the UE's processing circuitry configured to: perform one or more of the actions described herein as performed by the wireless device 130.

46. The communication system of embodiment 45, further including the UE.

47. The communication system of embodiment 46, further including the base station, wherein the base station comprises a radio interface configured to communicate with the UE and a communication interface configured to forward to the host computer the user data carried by a transmission from the UE to the base station.

48. The communication system of embodiment 46 or 47, wherein:
the processing circuitry of the host computer is configured to execute a host application; and
the UE's processing circuitry is configured to execute a client application associated with the host application, thereby providing the user data.

49. The communication system of embodiment 46 or 47, wherein:
the processing circuitry of the host computer is configured to execute a host application, thereby providing request data; and
the UE's processing circuitry is configured to execute a client application associated with the host application, thereby providing the user data in response to the request data.

51. A method implemented in a user equipment (UE), comprising one or more of the actions described herein as performed by the wireless device 130.

52. The method of embodiment 51, further comprising:
providing user data; and
forwarding the user data to a host computer via the transmission to the base station.

55. A method implemented in a communication system including a host computer, a base station and a user equipment (UE), the method comprising:
at the host computer, receiving user data transmitted to the base station from the UE, wherein the UE performs one or more of the actions described herein as performed by the wireless device 130.

56. The method of embodiment 55, further comprising:
at the UE, providing the user data to the base station.

57. The method of embodiment 56, further comprising:
at the UE, executing a client application, thereby providing the user data to be transmitted; and
at the host computer, executing a host application associated with the client application.

58. The method of embodiment 56, further comprising:
at the UE, executing a client application; and
at the UE, receiving input data to the client application, the input data being provided at the host computer by executing a host application associated with the client application,
wherein the user data to be transmitted is provided by the client application in response to the input data.

61. A base station configured to communicate with a user equipment (UE), the base station comprising a radio interface and processing circuitry configured to perform one or more of the actions described herein as performed by the first network node 111.

65. A communication system including a host computer comprising a communication interface configured to receive user data originating from a transmission from a user equipment (UE) to a base station, wherein the base station comprises a radio interface and processing circuitry, the base station's processing circuitry configured to perform one or more of the actions described herein as performed by the first network node 111.

66. The communication system of embodiment 65, further including the base station.

67. The communication system of embodiment 66, further including the UE, wherein the UE is configured to communicate with the base station.

68. The communication system of embodiment 67, wherein:
the processing circuitry of the host computer is configured to execute a host application;
the UE is configured to execute a client application associated with the host application, thereby providing the user data to be received by the host computer.

71. A method implemented in a base station, comprising one or more of the actions described herein as performed by the first network node 111.

75. A method implemented in a communication system including a host computer, a base station and a user equipment (UE), the method comprising:
at the host computer, receiving, from the base station, user data originating from a transmission which the base station has received from the UE, wherein the UE performs one or more of the actions described herein as performed by the wireless device 130.

76. The method of embodiment 75, further comprising:
at the base station, receiving the user data from the UE.

77. The method of embodiment 76, further comprising:
at the base station, initiating a transmission of the received user data to the host computer.

1. A method performed by a first network node, the method being for configuring a wireless device, the first network node operating in the wireless communications network, the method comprising:
configuring the wireless device with one or more configured grants to transmit data in inactive state, the data having a size smaller than a threshold, the one or more configured grants being configured by the first network node with a relation to one or more occasions to monitor a paging channel between the first network node and the wireless device.

2. The method according to claim 1, wherein the relation is one of:
a fraction of the one or more occasions to monitor the paging channel,
a multiple of the one or more occasions to monitor the paging channel,
an alignment in time with the one or more occasions to monitor the paging channel,
a subset of one or more first occasions to monitor the paging channel, already configured in the wireless device, and
with the proviso that the wireless device is configured with one or more first configured grants to transmit data in inactive state, the data having a size smaller than the threshold, an instruction to one of:
i. disable monitoring of the paging channel, and
ii. monitor the paging channel during a subset of the configured one or more occasions to monitor the paging channel.

3. The method according to claim 1, wherein the configuring is performed via at least one of:
a parameter in a ConfiguredGrantConfig information element, and
an offset with respect to the one or more occasions to monitor the paging channel.

4. (canceled)

5. (canceled)

6. The method according to claim 1, wherein the method further comprises:
obtaining a first indication that the wireless device is configured with one or more first configured grants to transmit data in inactive state, the data having the size smaller than the threshold, and
refraining from paging the wireless device, based on the obtained first indication;
wherein the method further comprises, based on the obtained first indication;
buffering first data to be transmitted to the wireless device, and
sending the buffered first data to the wireless device in response to a subsequent configured grant to transmit data in inactive state, the data having a size smaller than the threshold.

7. (canceled)

8. The method according to claim 1, wherein the configuring comprises sending an indication and the indication is a second indication, and wherein method further comprises at least one of:
sending a third indication to a second network node, the third indication indicating that the wireless device is configured with one or more configured grants to transmit data in inactive state, and
sending a fourth indication to the second network node, the fourth indication indicating that a configuration of one or more configured grants to transmit data in inactive state by the wireless device has been cancelled or released.

9. The method according to claim 2, wherein the relation further specifies that with the proviso that a number of one or more first configured grants to transmit data in inactive state is skipped, the wireless device is to monitor a subset of the configured one or more configured grants to transmit data in inactive state for downlink transmissions from the first network node.

10. A method performed by a wireless device, the method being for obtaining a configuration, the wireless device operating in the wireless communications network, the method comprising:
obtaining an indication from a first network node, the indication configuring the wireless device with one or more configured grants to transmit data in inactive state, the data having a size smaller than a threshold, the one or more configured grants being configured by the first network node with a relation to one or more occasions to monitor a paging channel between the first network node and the wireless device.

11. The method according to claim 10, wherein the relation is one of:
a fraction of the one or more occasions to monitor the paging channel,
a multiple of the one or more occasions to monitor the paging channel,
an alignment in time with the one or more occasions to monitor the paging channel,
a subset of one or more first occasions to monitor the paging channel, already configured in the wireless device, and
with the proviso that the wireless device is configured with one or more first configured grants to transmit data in inactive state, the data having a size smaller than the threshold, an instruction to one of:
i. disable monitoring of the paging channel, and
ii. monitor the paging channel during a subset of the configured one or more occasions to monitor the paging channel.

12. The method according to claim 10, wherein the obtaining is performed via at least one of:
a parameter in a ConfiguredGrantConfig information element,
an offset with respect to the one or more occasions to monitor the paging channel.

13. (canceled)

14. (canceled)

15. The method according to claim 10, wherein the method further comprises:
receiving first data from the first network node in response to a subsequent configured grant to transmit data in inactive state, the data having a size smaller than the threshold.

16. The method according to claim 11, wherein the relation further specifies that with the proviso that a number of one or more first configured grants to transmit data in inactive state is skipped, the wireless device is to monitor a subset of the configured one or more configured grants to transmit data in inactive state for downlink transmissions from the first network node.

17. A first network node, for configuring a wireless device, the first network node being configured to operate in the wireless communications network, the first network node being further configured to:
configure the wireless device with one or more configured grants to transmit data in inactive state, the data being configured to have a size smaller than a threshold, the one or more configured grants being configured by the first network node with a relation to one or more occasions to monitor a paging channel between the first network node and the wireless device.

18. The first network node according to claim 17, wherein the relation is configured to be one of:
a fraction of the one or more occasions to monitor the paging channel,
a multiple of the one or more occasions to monitor the paging channel,
an alignment in time with the one or more occasions to monitor the paging channel,
a subset of one or more first occasions to monitor the paging channel, already configured in the wireless device, and
with the proviso that the wireless device is configured with one or more first configured grants to transmit data in inactive state, the data being configured to have a size smaller than the threshold, an instruction to one of:
i. disable monitoring of the paging channel, and
ii. monitor the paging channel during a subset of the configured one or more occasions to monitor the paging channel.

19. The first network node according to claim 17, wherein the configuring is configured to be performed via at least one of:
a parameter in a ConfiguredGrantConfig information element, and
an offset with respect to the one or more occasions to monitor the paging channel.

20. (canceled)

21. (canceled)

22. The first network node according to claim 17, wherein the first network node is further configured to:
obtain a first indication that the wireless device is configured with one or more first configured grants to transmit data in inactive state, the data being configured to have the size smaller than the threshold, and
refrain from paging the wireless device, based on the first indication configured to be obtained:
wherein the method further comprises, based on the obtained first indication;
buffer first data to be transmitted to the wireless device, and
sending the buffered first data to the wireless device in response to a subsequent configured grant to transmit data in inactive state, the data having a size smaller than the threshold.

23. (canceled)

24. The first network node according to claim 17, wherein the configuring is configured to comprise sending an indication, and the indication is configured to be a second indication, and wherein first network node is further configured to at least one of:
send a third indication to a second network node, the third indication being configured to indicate that the wireless device is configured with one or more configured grants to transmit data in inactive state, and
send a fourth indication to the second network node, the fourth indication being configured to indicate that a configuration of one or more configured grants to transmit data in inactive state by the wireless device has been cancelled or released.

25. The first network node according to claim 18, wherein the relation is further configured to specify that, with the proviso that a number of one or more first configured grants to transmit data in inactive state is skipped, the wireless device is to monitor a subset of the configured one or more configured grants to transmit data in inactive state for downlink transmissions from the first network node.

26. A wireless device, for obtaining a configuration, the wireless device being configured to operate in the wireless communications network, the wireless device being further configured to:
obtain an indication from a first network node, the indication being configured to configure the wireless device with one or more configured grants to transmit data in inactive state, the data being configured to have a size smaller than a threshold, the one or more configured grants being configured by the first network node with a relation to one or more occasions to monitor a paging channel between the first network node Apr. 4, 2019 and the wireless device.

27. The wireless device according to claim 26, wherein the relation is configured to be one of:
a fraction of the one or more occasions to monitor the paging channel,
a multiple of the one or more occasions to monitor the paging channel,
an alignment in time with the one or more occasions to monitor the paging channel,
a subset of one or more first occasions to monitor the paging channel, already configured in the wireless device, and
with the proviso that the wireless device is configured with one or more first configured grants to transmit data in inactive state, the data being configured to have a size smaller than the threshold, an instruction to one of:
i. disable monitoring of the paging channel, and
ii. monitor the paging channel during a subset of the configured one or more occasions to monitor the paging channel.

28. The wireless device according to claim 26, wherein the obtaining is configured to be performed via at least one of:
a parameter in a ConfiguredGrantConfig information element,
an offset with respect to the one or more occasions to monitor the paging channel.

29. (canceled)

30. (canceled)

31. The wireless device according to claim 26, wherein the wireless device is further configured to:
receive first data from the first network node in response to a subsequent configured grant to transmit data in inactive state, the data being configured to have a size smaller than the threshold.

32. The wireless device according to claim 27, wherein the relation is further configured to specify that with the proviso that a number of one or more first configured grants to transmit data in inactive state is skipped, the wireless device is to monitor a subset of the configured one or more configured grants to transmit data in inactive state for downlink transmissions from the first network node.
